(19) United States
(12) Patent Application Publication
(10) Pub. No.: US 2025/0053822 A1
(43) Pub. Date: Feb. 13, 2025

(54) UNLEARNING A TRAINING EXAMPLE FROM A MODEL

(71) Applicant: Hirundo LTD, Tel Aviv (IL)

(72) Inventors: Oded SHMUELI, Nofit (IL); Ben Mordechay LURIA, Tel Aviv (IL)

(73) Assignee: Hirundo LTD, Tel Aviv (IL)

(21) Appl. No.: 18/792,679

(22) Filed: Aug. 2, 2024

Related U.S. Application Data
(60) Provisional application No. 63/532,404, filed on Aug. 13, 2023.

(51) Int. Cl. G06N 3/091

(52) U.S. Cl. CPC G06N 3/091

(57) ABSTRACT

A method of unlearning a training example from a neural network, comprising: during training of the neural network on a training dataset, recording a plurality of recordings in a recording dataset, wherein a recording includes weight values of the neural network at the time at which the recording is recorded, selecting an unlearning training example to unlearn from the neural network, computing a total-loss value of a change in a loss function for each of plurality of training examples induced by a change of weights of the neural network in response to the unlearning training example, determining a certain recording to use to remove the unlearning training example according to the total-loss values, and re-training the neural network from the determined certain recording using an adapted training dataset excluding the unlearning training example; and producing an unlearned neural network.

### RELATED APPLICATION(S)

This application claims the benefit of priority under 35 USC § 119(e) of U.S. Provisional Patent Application No. 63/532,404 filed on Aug. 13, 2023, the contents of which are incorporated by reference as if fully set forth herein in their entirety.

### BACKGROUND

The present invention, in some embodiments thereof, relates to machine learning models and, more specifically, but not exclusively, to a system and a method for unlearning a training example from a machine learning model.

Unlearning in a neural network involves removing the influence of specific training data without retraining the entire model from scratch. By adjusting the model's parameters or reweighting the training examples, the impact of the targeted data is minimized. This ensures the model forgets unwanted information while retaining overall performance.

### SUMMARY

According to a first aspect, a computer implemented method of unlearning a training example from a neural network, comprises: during training of the neural network on a training dataset, recording a plurality of recordings in a recording dataset, wherein a recording includes weight values of the neural network at the time at which the recording is recorded, selecting an unlearning training example to unlearn from the neural network, computing a total-loss value of a change in a loss function for each of plurality of training examples induced by a change of weights of the neural network in response to the unlearning training example, determining a certain recording to use to remove the unlearning training example according to the total-loss values, and re-training the neural network from the determined certain recording using an adapted training dataset excluding the unlearning training example, and producing an unlearned neural network.

In a further implementation form of the first aspect, the recording includes a checkpoint comprising: (i) a change in a loss function value for a first training example induced by a change of weights of the neural network in response to a second training example, and (ii) a time during the training associated with the change in the loss function value, wherein the first training example and the second training example are selected from a plurality of training examples of the training dataset.

In a further implementation form of the first aspect, in response to determining that the total-loss is within a range indicating non-significant overall loss, removing the unlearning training example with no neural network weight alteration.

In a further implementation form of the first aspect, in response to determining that the total-loss is greater than a first threshold indicating the unlearning example significantly reduced overall loss during training, identifying a recording with an increase in loss as compared to the latest recording greater than a second threshold, and re-training the neural network starting from the identified recording on an adapted training dataset that excludes the unlearning training example.

In a further implementation form of the first aspect, in response to determining that the total-loss is less than a second threshold indicating the unlearning example significantly increased overall loss during training, re-training the neural network from the most recent recording on an adapted training dataset that excludes the unlearning training example.

In a further implementation form of the first aspect, the unlearning training example comprises a plurality of unlearning training examples, wherein the selected recording providing at least a defined percentage of improvement in the overall model loss over all training examples thereafter until the most recent available recording.

In a further implementation form of the first aspect, further comprising: training a second neural network on a second training dataset of a plurality of records, wherein a record includes a training example of the neural network, or a record includes an example from a held out test set of examples that have not participated in training or another previously removed unlearned example, a loss computed by an unlearned neural network when presented with the unlearned training example, and a binary label indicating whether the unlearned training example is a training example, or a held out example or a previously removed example, feeding the unlearned example into the second neural network, in response to an outcome of the second neural network indicating a training example, generating an indication that the removal of the unlearning example is insufficient.

In a further implementation form of the first aspect, further comprising confirming the effective removal of the unlearning training example from the neural network, by: checking an influence of the unlearning training example on a prediction of an unlearned version of the neural network on an input during training of a removed unlearned training example; and in response to the influence being higher according to a requirement in comparison with the influence on the prediction by at least one other training example, generating an indication that the removal is insufficient.

According to a second aspect, a method of unlearning a training example from a neural network, comprises: during training of the neural network on a training dataset, recording a plurality of recordings in a recording dataset, wherein a recording includes weights values of the neural network at a time in which the recording is recorded, selecting an unlearning training example to unlearn from the neural network, providing per recording, a total-loss-change parameter as an overall loss reduction effect of the unlearning training example on at least one different training example, computing per recording, a total sum of values or of absolute values, of the total-loss change parameter for the plurality of training examples, and assigning a weight for each of the plurality of training examples, and using the weight of each training example to modify its impact on loss computation during further training to account for the removal of the unlearning training example on each of the plurality of training examples' associated loss, said further training computed from a preceding recording and/or from a current recording forward.

In a further implementation form of the second aspect, a value of the total-loss-change parameter>0 indicates loss reduction for a certain different training example due to the unlearning training example, and wherein a value of the total-loss-change parameter<0 indicates loss increase for the certain different training example due to the unlearning training example.

In a further implementation form of the second aspect, in further training the weight of each training example is increased in proportion to a magnitude of an absolute value of a total-loss-change parameter of the training example due to the unlearning example relative to a sum of the magnitudes of total-loss-change parameters of the plurality of training examples due to the unlearning example.

In a further implementation form of the second aspect, the total sum of values comprises the total sum of the absolute values, and in response to the total sum exceeding a threshold, adjusting the total sum according to a threshold.

In a further implementation form of the second aspect, a value of a current weight of a certain training example is defined as a value of the current weight plus a variable-parameter multiplied by an absolute value of the total-loss-change parameter for the certain training example divided by the sum of absolute values of the total-loss-change parameter of all the training examples.

In a further implementation form of the second aspect, a value of a current weight of a certain training example is defined as a value of its current weight minus a positive value variable-parameter multiplied by the value of the total-loss-change parameter for the certain training example divided by the sum of absolute values of the total-loss-change parameter of all the training examples.

In a further implementation form of the second aspect, a plurality of the weights are computed by solving a linear equation of a form M*Q=−J wherein Q denote a column vector of variables, M denotes a matrix of n squared entries wherein n is the number of training examples, and wherein the entry M_im entry at row i and column m is a total loss influence of a training example e_i on a training example e_m, J denotes a column vector, wherein its m'th entry J_m is the total-loss change of training example e_m due to the unlearning training example, wherein the linear equation is solved for the variables, using each variable to adjust each corresponding weight of a corresponding training example.

According to a third aspect, a computer implemented method for unlearning a text element from a large language model (LLM), comprises: accessing the text element for unlearning, wherein the text element is represented as a plurality of tokens, generating a plurality of text training examples by changing a token or a series of contiguous tokens by replacing the token or the series of tokens by another token or another series of token by randomly selecting among candidate tokens with a probability above a threshold according to a prediction of the LLM on the text clement when the token or the series is masked away from the LLM input, and training the LLM on the plurality of text training examples to create an adapted LLM for which it is determined that the text element has been sufficiently unlearned.

In a further implementation form of the third aspect, further comprising: accessing vector embeddings of a plurality of text training examples used to train the generative model, computing a text vector embedding of the text element, searching for the text vector embedding within the vector embeddings of the plurality of text training examples, identifying vector embeddings in proximity to the text vector embedding and unlearning according to at least one of (i) a whole text training example corresponding to identified vector embeddings, and (ii) a sub-text of the whole text training example including the text element, (iii) retain the whole text training example without unlearning, or (iv) choose probabilistically among options (i), (ii) and (iii).

In a further implementation form of the third aspect, further comprising determining that the text element has been sufficiently unlearned by: for each presentation of the text element and each of the plurality of text training examples presented separately to the LLM excluding masking, computing a distance between the LLM's prediction and the presentation to the LLM, listing the text element and each of the plurality of text training examples according to an increasing distance order, and in response to the text element being excluded from an initial portion of the list satisfying a requirement indicating a small distance, it is determined that the text element has been sufficiently unlearned by the LLM.

In a further implementation form of the third aspect, the distance comprises a number of mis-predicted tokens.

In a further implementation form of the third aspect, the LLM has been previously trained using a non-supervised approach.

In a further implementation form of the third aspect, the LLM comprises a fine-tuned pre-trained LLM model trained with labelled data.

In a further implementation form of the third aspect, the LLM comprises a fine-tuned LLM model trained using an unsupervised approach, wherein the token or series of tokens that is replaced is used in the fine tuning.

In a further implementation form of the third aspect, the LLM model comprises a generative model for generating images, wherein the text element is obtained by an image-to-text conversion process in which image data is pre-processed to extract features and/or information from the image which is described as text.

According to a fourth aspect, a computer implemented method for unlearning an image from a generative model that creates image, comprises: accessing the image for unlearning, wherein the image comprises a plurality of cells including pixels and at least one channel, generating a plurality of image training examples by selecting a plurality of contiguous regions in the image, for each region of the plurality of regions, selecting a number of cells for inclusion in the region, and modifying intensity of the at least one channel of pixels of cells of the region, and continuing training the generative model on the plurality of image training examples with modified regions to create an adapted generative model.

In a further implementation form of the fourth aspect, the training of the generative model is terminated when it is determined that the selected image has been sufficiently unlearned by the adapted generative model.

In a further implementation form of the fourth aspect, a region is created by selecting a seed cell among available cells that are candidates for inclusion in a region, and adding the selected cell for inclusion in the region that neighbors the selected cell in a plurality of iterations until no available cells remain and/or the region has reached or exceeds a predefined maximum number of cells.

In a further implementation form of the fourth aspect, the plurality of regions are selected such that the cells of the image are included in at least one region of the plurality of regions.

In a further implementation form of the fourth aspect, a number of cells selected for inclusion in the region is selected from a range of 1 to a total number of cells in the image divided by a hyperparameter less a total number of cells already selected in at least one other region.

According to a fifth aspect, a method of debugging a deployed neural network, comprises: monitoring a prediction of the neural network in response to an input for detecting a faulty prediction in disagreement with an expectation for the input, identifying the unlearning training examples likely leading to the faulty prediction, and unlearning the unlearning training examples from the neural network according to the method of the first aspect or any of the implementation forms of the first aspect.

In a further implementation form of the fifth aspect, the identifying is performed by computing a dot product between a gradient vector with respect to weights of at least one layer of the neural network during training of each of a plurality of training examples, and the gradient vector with respect to weights of said layer in response to being fed the said input, and identifying the unlearning training examples according to a highest value of the dot product.

In a further implementation form of the fifth aspect, after at least two checkpoints have been recorded, a plurality of hypothetical examples are created by: creating a plurality of clusters, wherein a cluster includes training examples based on the neural network's vector embedding of a training example that is implied by a current state of the neural network being trained, for each cluster, selecting at least one training example input part, and deriving at least one hypothetical example for each candidate label from the at least one training example input parts wherein, a hypothetical example input denoted x is computed as a function of x1, . . . , xm, wherein xi denotes the input part of an example in the cluster, and calculating gradient vectors for the at least one hypothetical example for each subsequent time a recording is recorded, wherein the calculated gradient vectors of the plurality of hypothetical training examples are used for computing a dot product for identifying the unlearning training examples likely correlated with the input of an example leading to the faulty prediction during inference whose input part is close to the hypothetical example input part and having an identical label to it.

In a further implementation form of the fifth aspect, the gradient vectors for the at least one new training example is computed in a feed forward only mode without learning.

In a further implementation form of the fifth aspect, the gradient vectors are computed prior to inference time during which the input is fed into the neural network.

In a further implementation form of the fifth aspect, during the inference, a gradient vector of a hypothetical example closest to the input-caused gradient vector is found by performing a vector search for locating a highest dot product hypothetical example gradient vector, and providing at least one training example most influential in reducing a loss of the hypothetical example associated with the highest dot product.

In a further implementation form of the fifth aspect, the function comprises an average.

In a further implementation form of the fifth aspect, a certain training example is presented to the neural network at least two times between two recordings, and further comprising monitoring a number of times each training example is presented to the neural network between recordings.

In a further implementation form of the fifth aspect, an average of a learning rate between neighboring recordings is used.

According to a sixth aspect, a computer implemented method of adapting a training dataset for training a neural network, comprises: during training of the neural network on the training dataset, recording a plurality of recordings in a recording dataset, wherein a recording includes weight values of the neural network at a time at which the recording is recorded, computing a total-loss-change of the change in loss function value for each training example of a plurality of training examples of the training dataset over a plurality of times during the training, creating a reduced training dataset by removing training examples having the total-loss-change below a threshold said total-loss-change summed over all training examples, and subsequently training the neural network on the reduced training dataset.

In a further implementation form of the sixth aspect, further comprising: ranking the plurality of training examples according to respective changes in the total-loss-change function value of the neural network during training due to respective example, further comprising presenting on a display a subset of training examples having changes in the total-loss function value below a threshold and/or meeting a first requirement indicating low changes, and presenting labels associated with each training example of the subset.

In a further implementation form of the sixth aspect, further comprising removing a determined as mislabeled training example from the training dataset.

In a further implementation form of the sixth aspect, the total-loss-change is computed for a sub-set of training examples for which presentation to the neural network during training leads to the change in the loss function value less than a first threshold for a plurality of times, wherein said number of times is greater than a second threshold.

In a further implementation form of the sixth aspect, further comprising removing a training example from the sub-set having a number denoted q of close neighboring training examples with distance smaller than a distance denoted beta, wherein q and beta are hyperparameters.

In a further implementation form of the sixth aspect, further comprising: removing a first training example from the training dataset, wherein the first training example includes (i) an output feature of the first training example that is close according to a second requirement to an output feature of a second training example, (i) an input feature of the first training example that is close according to a third requirement to an input feature of the second training example, and (iii) there are at least a predefined number of first training examples that are within a distance satisfying a fourth requirement of intermediate network activation due to the input feature.

In a further implementation form of the sixth aspect, the third requirement and the fourth requirement are computed for vectors computed from neurons that are inputs to a selected layer that is among the last layers of the neural network prior and including a logits units layer.

In a further implementation form of the sixth aspect, further comprising: iteratively removing a plurality of training examples during a plurality of times during the training, computing an accuracy of the neural network trained on the reduced training dataset, and in response to the accuracy decreasing by an amount greater than a threshold in comparison to a previously computed accuracy, re-instating at least one of the removed plurality of training examples.

According to a seventh aspect, a method comprises: improving a method for identifying membership of an unlearned training example in a training set of training examples of a neural network using another neural network by adjusting a score produced by the another neural network according to the number of training examples close to the unlearned example that are not removed.

According to an eighth aspect, a method comprises: producing a neural network whose weights are produced by training over a subset of a training set of training examples excluding the sub-set of removed examples that is approximating a neural network with the same architecture trained on the same training set of training examples from which a sub-set of removed examples is removed, and using the produced network to assess the unlearning degree of a neural network modified to reflect unlearning of the sub-set of removed unlearning examples.

According to a ninth aspect, a method for confirming the effective removal of an unlearning training example from a model comprises: checking an influence of the unlearning training example on a prediction of an unlearned version of the model on an input during training of a removed unlearned training example, and in response to the influence being higher according to a requirement in comparison with the influence on the prediction by at least one other training example, generating an indication that the removal is insufficient.

In a further implementation form of the ninth aspect, said generating the indication is followed by further unlearning actions.

In a further implementation form of the ninth aspect, further unlearning actions include further weight changes to effect unlearning and/or using an earlier recording with which to begin unlearning actions.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for unlearning a model and/or implementing other features, in accordance with some embodiments of the present invention;

FIG. 2 is another block diagram of an exemplary computing system for unlearning, optimizing a training dataset, and/or other features, in accordance with some embodiments of the present invention;

FIG. 3 is a flowchart of an exemplary method for generating a reduced training dataset for training a model, in accordance with some embodiments of the present invention;

FIG. 4A is a method for unlearning a training example from a trained model, in accordance with some embodiments of the present invention;

FIG. 4B is a flowchart of an exemplary method of unlearning a training example from a trained model in accordance with some embodiments of the present invention;

FIG. 5A is a method for unlearning a training example from a trained model, in accordance with some embodiments of the present invention;

FIG. 5B is a flowchart of other exemplary methods of unlearning a training example from a trained model, in accordance with some embodiments of the present invention;

FIG. 6A is a flowchart of a method for unlearning a text from a trained generative model, optionally a large language model (LLM), in accordance with some embodiments of the present invention;

FIG. 6B is a flowchart of another exemplary method of unlearning a training example from a trained generative model, in accordance with some embodiments of the present invention;

FIG. 7 is a method of unlearning an image from a generating model, in accordance with some embodiments of the present invention;

FIG. 8 is a flowchart of a method of debugging a deployed neural network model, in accordance with some embodiments of the present invention; and

FIG. 9 is a pseudocode for debugging a model that generated a faulty prediction, in accordance with some embodiments of the present invention.

### DETAILED DESCRIPTION

The present invention, in some embodiments thereof, relates to machine learning models and, more specifically, but not exclusively, to a system and a method for unlearning a training example from a machine learning model.

As used herein, the terms model, machine learning model, trained model, neural network and neural network model, may sometimes be interchanged. A neural network may be a feed-forward neural network, a recurrent neural network, a transformer network or any kind of similar network.

It is noted that parameters such as constants, variables, and/or thresholds described herein may be functions (e.g., of numbers), for example, the total loss of the model (as described herein) and/or of other parameters known in the art of data science and/or machine learning which may not be explicitly described herein.

As used herein, the term checkpoint represents a not necessarily limiting example of a recording of a recording dataset. Other data structures and/or representations may be used for the recording. Use of the term checkpoint is meant to serve as an example of the recording, and other data structures and/or representations may be substituted accordingly.

As used herein, the term “time” may refer to physical time, for example, a timestamp indicating actual physical time, or a counter by an internal clock, and the like. Alternatively or additionally, the term time used herein may not necessarily refer to physical time, but may refer to other indications of an order, for example, the ‘epoch number’ where an epoch is defined as presenting all training examples to the network (sometimes a portion thereof). In another example, the term time may refer to the order of presenting examples to the neural network. In case a batch is presented it could be the batch number and the number of examples in it and the position of this example, for example, batch #5 containing 16 examples and this example is 2nd.

It is to be understood that sometimes examples are described in pairs, for example, a pair may include a first training example and a second training example. Processing and/or other features described with reference to a pair may be applied, for example, to a single pair, a subset of pairs (which is less than all available pairs such as in the training dataset), or to all available pairs such as all pairs of the training dataset.

As used herein, the term threshold may be computed values based on, for example, one or more of: the number of training examples, the total loss of the trained model on all the training examples, user's directives, and/or other parameters described herein.

As used herein, loss, total-loss or total-loss-change may refer to actual loss or to a proxy for such a loss that serves as a more efficient to compute an approximation of the total-loss, total-loss-change or loss.

An aspect of some embodiments of the present invention relates to systems, methods, computing devices, and/or code instructions (stored on a data storage device and executable by one or more processors) for unlearning a training example from a neural network. During training of the neural network on the training dataset, recordings are recorded and included in a recording dataset. A recording includes weight values of the neural network at a time (and/or date) during which the recording is made. A training example to unlearn from the neural network, referred to herein as an unlearning training example, is selected. A total-loss of a change in a loss function is computed for each of the training examples, as described herein. The total-loss is induced by a change of weights of the neural network in response to the (presentation to the network of the) unlearning training example. A certain recording is used to remove the unlearning training example according to the total-loss is determined. The neural network is re-trained from the determined used recording by using an adapted training dataset excluding the unlearning training example. An unlearned neural network may be produced.

The unlearned neural network is the neural network which has been processed to unlearn the training example using one or more embodiments described herein.

Optionally, the recording may include (i) a change in a loss function value for a first training example induced by a change of weights of the neural network in response to a second training example, and/or (ii) the time during the training associated with the change in the loss function. The first training example and the second training example are selected from multiple training examples of the training dataset. Such recording that include (i) and/or (ii) may be referred to herein as a loss recording. The loss recording may be included in a checkpoint that records the state of weights and/or other parameters such as learning rate. Alternatively, the loss recording is in addition to checkpoints.

An aspect of some embodiments of the present invention relates to systems, methods, computing devices, and/or code instructions (stored on a data storage device and executable by one or more processors) for unlearning a training example from a neural network. During training of the neural network on the training dataset, recordings are recorded and included in a recording dataset. A recording includes weight values of the neural network at a time (and/or date) during which the recording is made. An unlearning training example to unlearn from the neural network is selected. A weight is associated with each training example. Per recording, a total-loss-change parameter is computed as an overall loss reduction effect of the unlearning training example on a different training example, as described herein. Per recording, a total sum of values or of absolute values, of the total-loss change parameter for the plurality of training examples, is computed as described herein. A weight may be assigned for each of the training examples. The weight of each training example may be used to modify the impact of the loss computation, that is increase or decrease it, during further training to account for the removal of the unlearning training example on each of the training examples' associated loss. Further training may be computed from a preceding recording and/or from a current recording forward.

An aspect of some embodiments of the present invention relates to systems, methods, computing devices, and/or code instructions (stored on a data storage device and executable by one or more processors) for generating a reduced training dataset for training a model (e.g., neural network). During training of the neural network on the training dataset, multiple checkpoints are recorded and included in a recording dataset. A recording includes weight values of the neural network at a time (and/or date) during which the recording is made. A total-loss of the change in loss function is computed (as described below) for each training example at multiple different times during the training. A reduced training dataset is created by removing training examples having a value of the total-loss below a threshold, which may represent training examples that do not significantly impact the learning of the model. The neural network may be trained on the reduced training dataset.

An aspect of some embodiments of the present invention relates to systems, methods, computing devices, and/or code instructions (stored on a data storage device and executable by one or more processors) for unlearning a text element from a text-based generative model, optionally a large language model (LLM). The text element for unlearning is accessed. The text element includes multiple tokens. Multiple text training examples are generated by changing a token or a series of contiguous tokens of each respective text training example, by replacing the token or the series by another token or another series, for example, by randomly selecting among candidate tokens with a probability above a threshold according to the generative model prediction of the text element when the token or the series is masked away from the LLM. The LLM is trained on the text training examples to create an adapted LLM for which it is determined that the text element has been sufficiently unlearned.

An aspect of some embodiments of the present invention relates to systems, methods, computing devices, and/or code instructions (stored on a data storage device and executable by one or more processors) for unlearning an image from a generative model that creates image. The image for unlearning is accessed. The image includes cells, where each cell includes one or more pixels. Each pixel is associated with one or more channels. Multiple image training examples are generated by the following process. Contiguous regions in the image are selected. For each region, a number of cells for inclusion in the region is selected. Intensity of the channel(s) of pixels of cells of the region is adapted, for example, randomly. The generative model is trained on the generated image training examples, for creating an adapted generative model. The adapted generated model may be created by training until it is determined that the image has been sufficiently unlearned.

An aspect of some embodiments of the present invention relates to systems, methods, computing devices, and/or code instructions (stored on a data storage device and executable by one or more processors) for debugging a deployed neural network. A prediction of the neural network made in response to an input, is monitored for detecting a faulty prediction in disagreement with an expectation for the input. One or more training examples likely leading to the faulty prediction are identified. The identified training examples, referred to herein an unlearning training examples, are to be unlearned. The unlearning training examples are unlearned from the neural network according, for example, to one or more embodiments described herein.

At least one embodiment described herein addresses the technical problem of unlearning a training example from a model. At least one embodiment described herein improves the technical field of machine learning models, by providing approaches for unlearning a training example from a trained or partially trained model. At least one embodiment described herein improves upon prior approaches for unlearning a training example from a model.

Examples of reasons for removal of a training example (e.g., denoted e_i) from the training dataset include: the example is mislabeled, the model finds the example ‘confusing’ or ‘borderline’, it is desired to have a model trained without some examples (e.g., produced by a specific measurement station) such as for experimental purposes, as part of debugging predictions, to adhere to legal requirements or due to an agreement with another party.

At least one embodiment described herein addresses the technical problem of reducing a size of a training dataset while retaining its effectiveness in training a model for handling new inputs. At least one embodiment described herein improves the technical field of machine learning models, by providing approaches for reducing a size of a training dataset while retaining its effectiveness in training a model for handling new inputs. At least one embodiment described herein improves upon prior approaches for reducing a size of a training dataset while retaining its effectiveness in training a model for handling new inputs.

Reducing the size of the training set while retaining its effectiveness in handling new inputs is a desirable goal, for several reasons. For example, usually a model is trained multiple times, therefore reducing the training set size will save both time and computing resources. In another example, even midway through training, reducing the size of the training set will contribute to a speedier and less resource consuming training. In yet another example, a large collection of training examples that are essentially providing the same information may hurt the model's generalization capabilities.

Once the example is removed from the training dataset, there may be a few possibilities: retrain the model from scratch on the set of retained examples which is ordinarily an expensive process in terms of time and computing resources, or alter the current model into a new one that better reflects the current set of training examples after removal. There may be a differentiation between exact removal in which the resulting model (retrained or altered) is one that could have been produced from the updated set of examples and approximate removal in which the model still retains meaningful information from the removed example or examples.

The trained model may be monitored post deployment, such as for aiming to understand an erroneous model prediction, for example, that disagrees with human intuition or real-world understanding and knowledge. The monitoring may be for a model which may have undergone unlearning of an example as described herein. It may be inevitable that there will be input examples on which the model produces wrong predictions. The model may produce wrong predictions even for some of the examples used in training (e.g., otherwise there may be overfitting). Some examples of reasons for a wrong model prediction include:

In one example, a wrong prediction may be due to mislabeled examples in the training data. Such examples sway the model into making wrong predictions. Locating these badly labelled examples may enable fixing the situation by removing the badly labelled examples and then either fixing the model to reflect unlearning these removed examples or retraining from scratch on the examples with corrected labels or on a training dataset that excludes these mislabeled examples. The labels on the example may be corrected. The effects of the mislabeled example may be unlearned from the model. The relabeled examples may be used in continuous training or in retraining from scratch. In another example, model confusion may occur between two classes of examples with two differing labels denoted L1 and L2. Such confusion can be determined by examining a confusion matrix denoted A where A_ij indicates the number of class Li examples predicted to be in class Lj. A high value entry indicates confusion between two classes (labels). The confusion may occur, for example, due to coverage issues such as not enough examples of either classes. Distribution issues of examples in these two classes may be viewed, for example, by using dimensional reduction methods. The problem of confusion by the model may be fixed by adding training examples, sometimes even synthetic ones. If insufficient training examples is not the cause then the model may be adapted to better differentiate between these two classes, for example, trying different hyperparameters, constructing a richer architecture (e.g., more convolutions), and/or using a different model architecture. Confusion may arise among more than one pair of classes. Some model alterations may be automated and tried out without users' involvement.

In yet another example, a subtler situation is when the root cause of mis-prediction is not one of the aforementioned. This may be an example denoted e which is mis-predicted, also referred to herein as faulty. Other training examples which are similar to the faulty example (e.g., modulo, i.e., based on, model similarity) may be identified, and presented on a display. Modulo model similarity may refer to picking up one or more unit (e.g., neuron) layers and presenting the activations of these units when an example is presented to the model, for example, as a vector embedding of the example. Examples of possible selection for such a layer include the layer of input units to the last layer of units in the model containing the predictions (logits). By viewing the presentation of similar training examples and of the example that led to the faulty prediction, the user may be able to tell why the model made the wrong prediction, for example, due to visual similarity of background or lighting conditions, the presence of a key phrase, etc. Alternatively or additionally, the faulty and similar examples may be inputted into a (e.g., GenAI-based) chatbot-like interface. The chatbot may be asked to analyze and list the exhibited similarities of these other training examples. Once the similarities are understood, areas for supplying additional training examples may be identified and recommended. Otherwise, the architecture and/or hyperparameters of the model may be adapted as discussed above.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

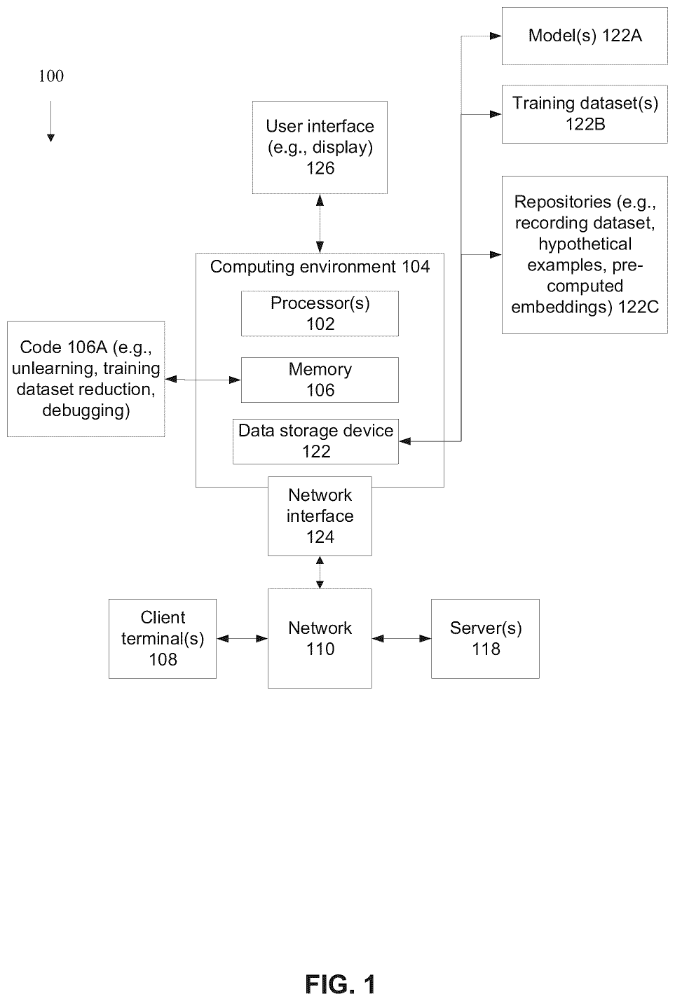

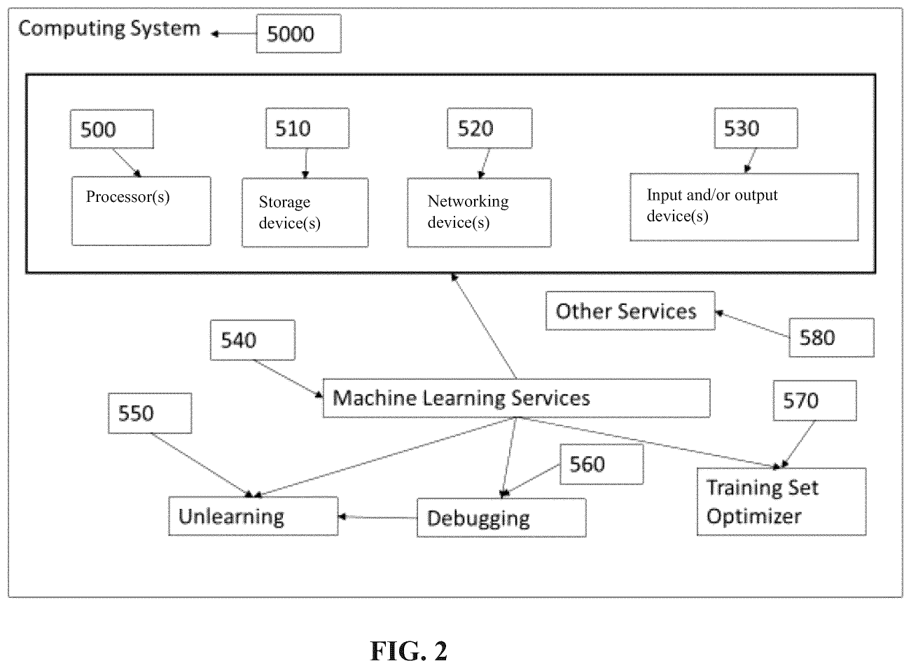

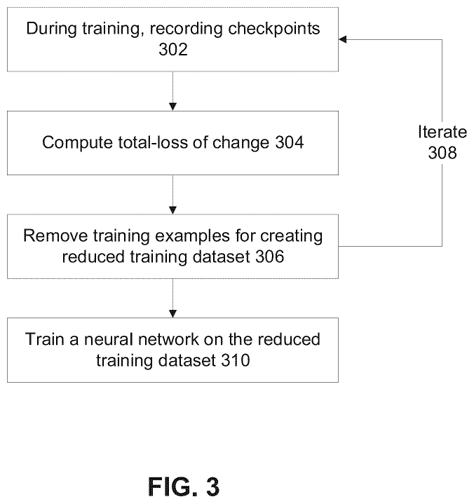

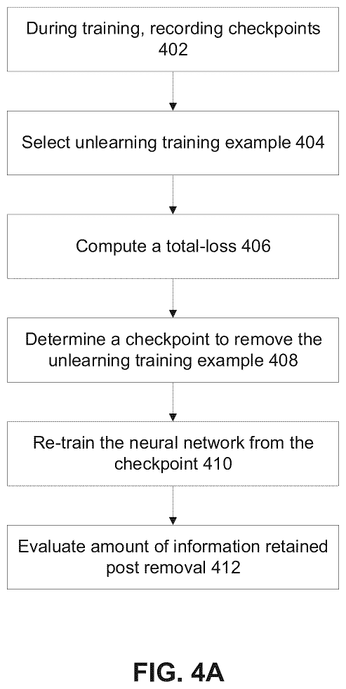

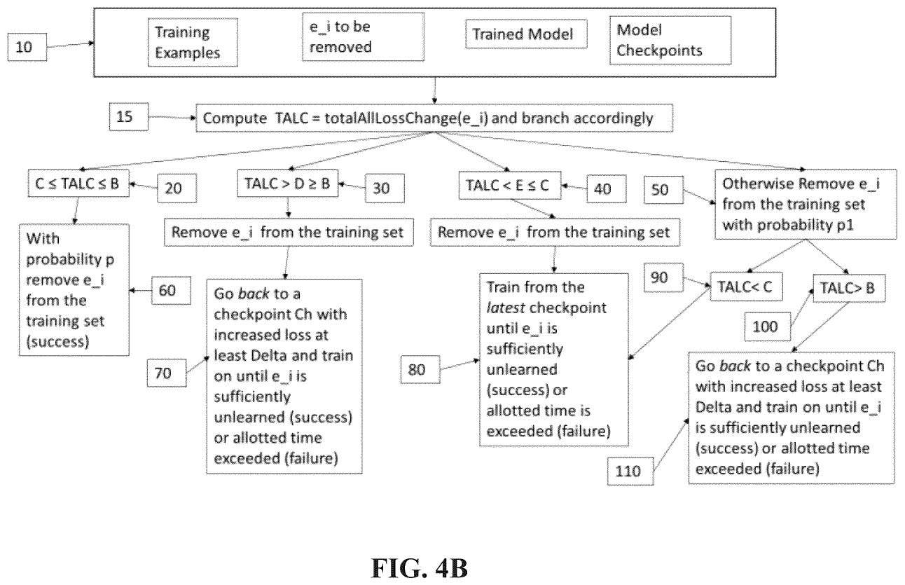

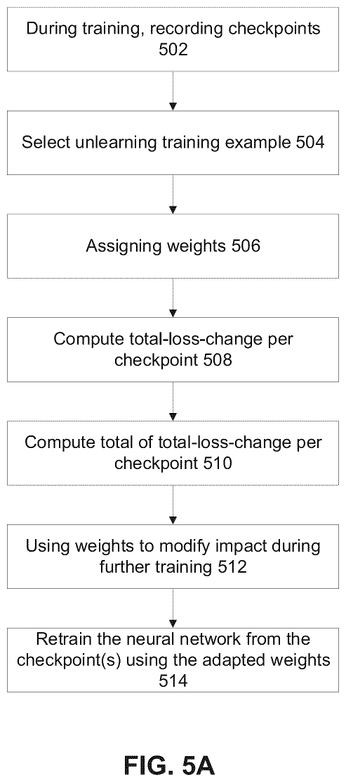

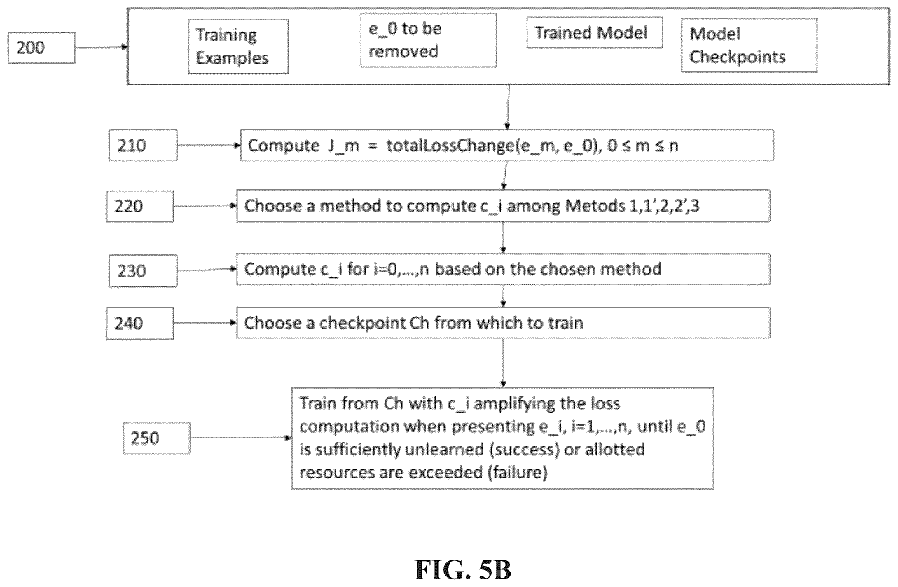

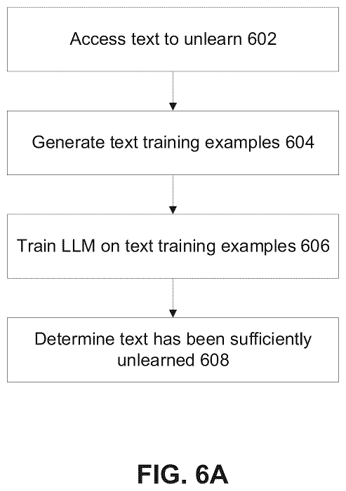

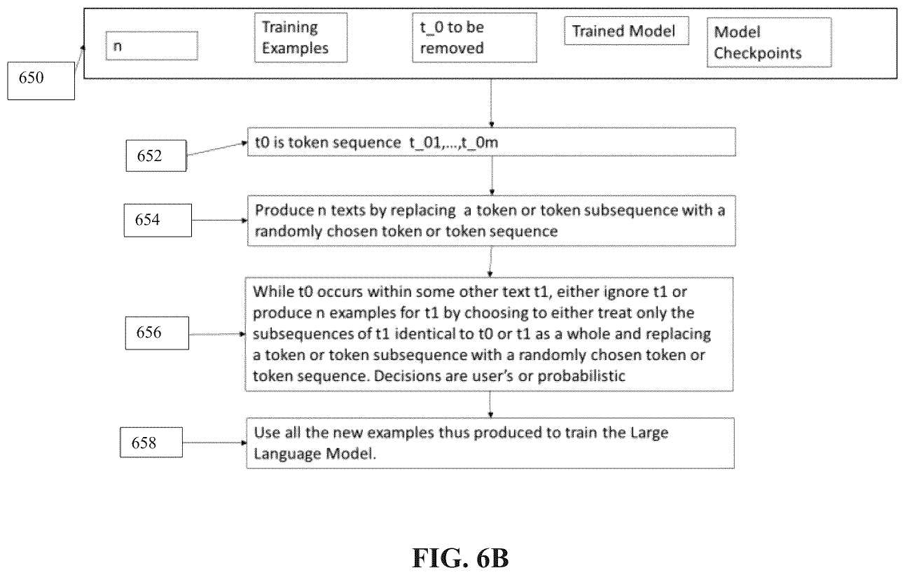

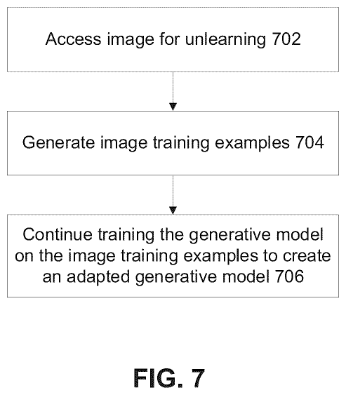

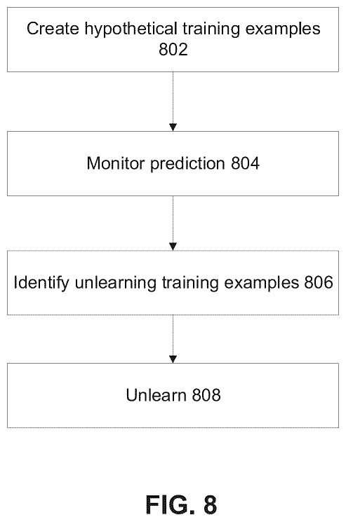

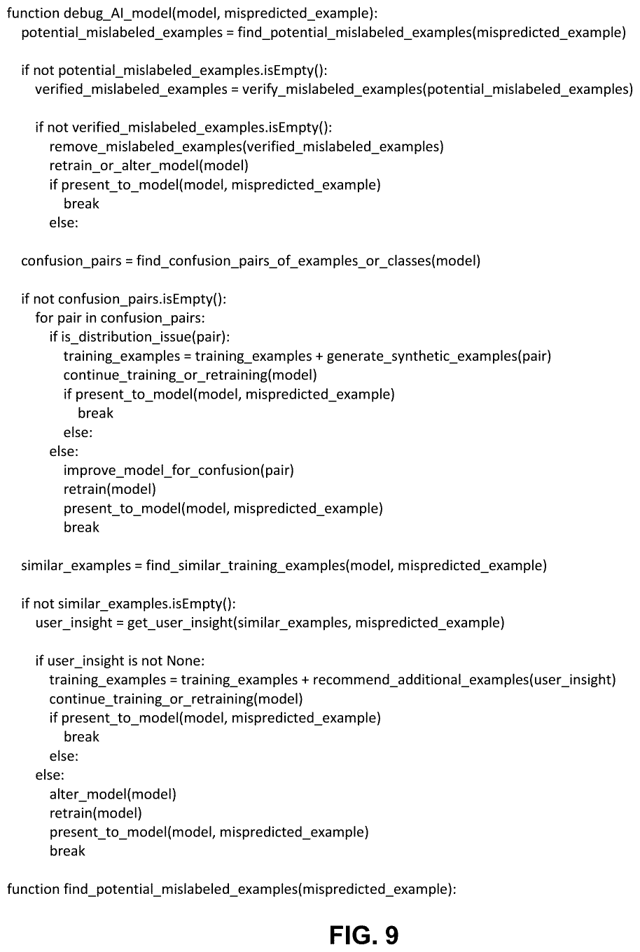

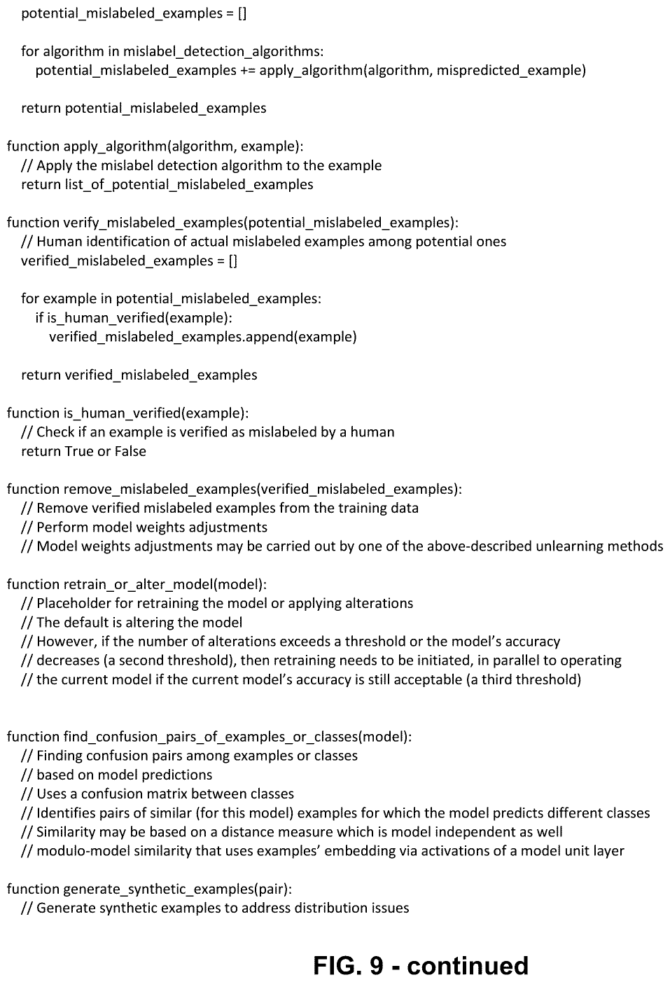

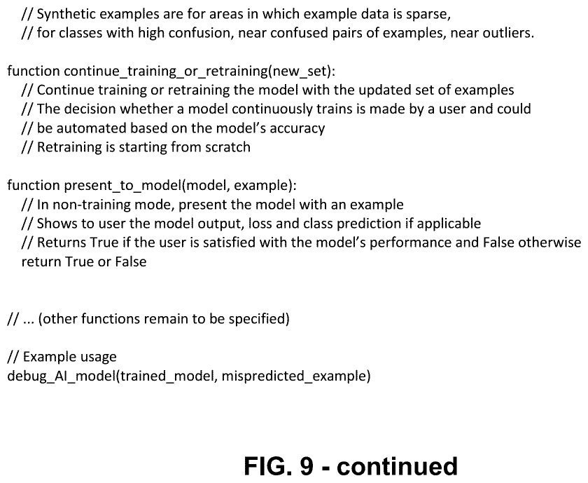

Reference is now made to FIG. 1, which is a block diagram of components of a system 100 for unlearning a model and/or implementing other features, in accordance with some embodiments of the present invention. Reference is also made to FIG. 2, which is another block diagram of an exemplary computing system 5000 for unlearning, optimizing a training dataset, and/or other features, in accordance with some embodiments of the present invention. Reference is also made to FIG. 3, which is a flowchart of an exemplary method for generating a reduced training dataset for training a model, in accordance with some embodiments of the present invention. Reference is also made to FIG. 4A, which is a method for unlearning a training example from a trained model, in accordance with some embodiments of the present invention. Reference is also made to FIG. 4B, which is a flowchart of an exemplary method of unlearning a training example from a trained model in accordance with some embodiments of the present invention. Reference is also made to FIG. 5A, which is a method for unlearning a training example from a trained model, in accordance with some embodiments of the present invention. Reference is also made to FIG. 5B, which is a flowchart of other exemplary methods of unlearning a training example from a trained model, in accordance with some embodiments of the present invention. Reference is also made to FIG. 6A, which is a flowchart of a method for unlearning a text from a trained generative model, optionally a large language model (LLM), in accordance with some embodiments of the present invention. Reference is also made to FIG. 6B, which is a flowchart of another exemplary method of unlearning a training example from a trained generative model, in accordance with some embodiments of the present invention. Reference is also made to FIG. 7, which is a method of unlearning an image from a generating model, in accordance with some embodiments of the present invention. Reference is also made to FIG. 8, which is a flowchart of a method of debugging a deployed neural network model, in accordance with some embodiments of the present invention. Reference is also made to FIG. 9, which is a pseudocode for debugging a model that generated a faulty prediction, in accordance with some embodiments of the present invention.

System 100 may implement the acts of the method described with reference to FIGS. 2-9, by processor(s) 102 of a computing environment 104 executing code instructions stored in a memory 106 (also referred to as a program store).

Computing environment 104 may be implemented as, for example one or more and/or combination of: a group of connected devices, a client terminal, a server, a virtual server, a computing cloud and/or other cloud platform such as a virtual private cloud (VPC), a virtual machine, a desktop computer, a thin client, a network node, and/or a mobile device (e.g., a Smartphone, a Tablet computer, a laptop computer, a wearable computer, glasses computer, and a watch computer).

Computing environment 104 may perform unlearning of one or more training examples (e.g., from training dataset 122B) from a model 122A, may reduce a size of training dataset 122B, and/or other features described herein.

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for unlearning one or more training examples from one or more models 122A. Services may be provided, for example, to one or more client terminals 108 over network 110, and/or to one or more server(s) 118 over network 110. Server(s) 118 may host one or more models 122A for which unlearning is desired. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web site hosted by computing environment 104. In an example, model 122A for which learning is to be performed may be hosted by computing environment 104. A user may use client terminal 108 to request unlearning of a certain training example from model 122A. In another example, model 122A may be hosted by server(s) 118. Computing environment 104 may perform unlearning for model 122A. In another example, training dataset 122B hosted by client terminal 108 is reduced by computing environment 104. In yet another example, training dataset 122B hosted by computing environment 104 is reduced in response to a request by client terminal 108.

In another example, computing environment 104 may be implemented as a standalone device (e.g., server, client terminal, smartphone) that includes locally stored code instructions 106A that implement one or more of the acts described with reference to FIGS. 2-9, for locally unlearning one or more training examples from model 122A, reducing training dataset 122B, and/or other features described herein. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-9 when executed by hardware processor(s) 102.

Computing environment 104 may include a data storage device 122 for storing data, for example, model(s) 122A for which unlearning is performed, training dataset(s) 122B of training examples for unlearning from model(s) 122A and/or for reduction, and one or more repositories 122C such as of a recording dataset set to store recordings, hypothetical examples, pre-computed embeddings, and the like. Data storage device 122 may be implemented as, for example, a memory, a local hard-drive, virtual storage, a removable storage unit, an optical disk, a storage device, and/or as a remote server and/or computing cloud (e.g., accessed using a network connection, for example AWS's S3).

Network 110 may be implemented as, for example, the internet, a local area network, a virtual network, a wireless network, a cellular network, a local bus, a point to point link (e.g., wired or via BlueTooth), and/or combinations of the aforementioned.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing environment 104 and/or client terminal(s) 108 include and/or are in communication with one or more user interfaces 126 designed for a user to provide input and/or view output. Exemplary user interfaces 126 include, for example, one or more of, a touchscreen, a display, gesture activation devices, a keyboard, a mouse, and voice activated software using speakers and microphone.

Referring now back to FIG. 2, components of computing system 5000 and components of system 100 described with reference to FIG. 1, may be, for example, interchanged, combined, correspond to each other, and the like. Computing system 5000 may correspond to computing environment 104. A processor(s) 500 may correspond to processor 102. A storage device(s) 510 may correspond to memory 106 and/or data storage device 122. A networking device(s) 520 may correspond to network interface 124. An input and/or output device(s) 530 may correspond to user interface 126. Machine learning services 540 (including unlearning 550, debugging 560, and training set optimizer 570) and/or other services 580 may correspond to code 106A. Other services 580 include, for example, model accuracy tracking, example shift tracking, economic impact tracking, and the like.

Computing system 500 may be implemented as one or a combination of: a hand-held device, a laptop, a tablet, a personal computer, a desktop, a server, a virtual computing server, a multi-processing system, a cloud computing facility, and a mainframe.

Processor(s) 500 is used for computations and may include one or a combination of: Central Processing Units (CPUs), a Graphical Processing Units (GPUs), Tensor Processing Units (TPUs), Field Programmable Gate Arrays (FPGAs), Application-Specific Integrated Circuits (ASICs), Digital Signal Processors (DSPs), Quantum Co-processors, Cryptography Accelerators, Analog Computing Components.

Storage device(s) 510 is used for storing data including raw data, unlabeled examples, labeled examples, computation results, administrative data, scientific data, and the like. Storage device(s) 510 may include one or a combination of memory devices including random access memory (RAM), Hard Disk Drive (HDD), Solid State Drive (SSD), Random Array of Inexpensive Disks (RAID), Magnetic Tapes, optical storage, biological storage, quantum storage, and cloud storage.

Input and/or output device(s) 530 include for example, keyboards, electronic pens, pointing devices (mice), hand waving devices, voice input devices, printers, screens, and 3D visualization systems.

Networking device(s) 520 optionally connects to networks, for example, a Bluetooth network, a Wi-Fi network, a cellular network, a Local Area Network (LAN), a Wide Area Network (WAN), a cloud virtual network, a quantum network.

The computing system 500 is used to implement one or more features described herein, including machine learning services. Examples of machine learning services include: training example set optimization, model training including supervised and unsupervised training (including training and refining Large Language Models (LLMs), model deployment and tracking, debugging of model predictions, model unlearning (of examples, including examples used in training as well as ones not used in training), and tracking model economic impact. Model training includes model optimization and unlearning examples during training. Model training may be implemented by processor(s) 500 that optionally utilizes the storage device 510 and/or network device 520. Training set optimization may identify likely unlabeled examples, areas of thin or overly dense coverage in example space of the training set, confusing examples (to the model), borderline examples, and more. Training set optimization and model debugging may be implemented by processor(s) 500 that optionally utilizes the storage device 510 and/or network device 520. Model debugging may include, for example, an analysis of how training examples influence model predictions, identifying likely mislabeled training examples, identifying confusing (to the model) pairs of training example classes, identifying confusing (to the model) pairs of training examples, and other features described herein. Unlearning a training example may include calculating its influence on the way the model impacts other training examples and undoing as much as possible the effects of this example that is to be unlearned (it may be a removed example or other examples). Users may interact with the computing system, for example, with training set optimization, model debugging and/or unlearning, optionally via the input and/or output device 530. These capabilities may operate automatically, optionally up to a point specified by parameters and thresholds.

During model training of a neural network (e.g., a feed forward neural network, a convolutional neural network, a recursive neural network, a transformer-based neural network) when a training example is presented to the network, model weights are updated. Due to such changes, the loss value associated with each training example (the one being presented as well as others) is changed. The loss measures how well the model predicts the training example's target values (usually in or derived from its last layer). There are various methods for computing the loss, depending on the task at hand (regression, classification), for example, mean squared error (MSE), mean absolute error (MAE), cross-entropy (CE).

High loss usually implies a poor prediction. Initially, upon start of training, the overall loss (i.e., the sum of the losses of individual training examples) is high and, it is expected that, as the training progresses the loss decreases from its initial value. It is noted that ordinarily the set of learning examples is divided into three subsets: training, validation and test. The validation set is commonly used during training usually for tuning hyperparameters and monitoring the model's performance during training to prevent overfitting, and the test set is commonly used to determine training quality post training. There are variations on training, such as leave-one-out type, K-Fold Cross-Validation and more.

Some mathematical notations used herein are now described.

In many training schemes, although not necessarily all, a learning example is of the form (x,y) where x denotes a vector of input features (e.g., in classification tasks the input features are usually values for attributes such as age, gender, and a photograph (i.e., image), while in regression tasks the input features may represent physical attribute values or signal values and the like) and y is a vector of output features (e.g., in a classification task y may be a natural number in the range [1 . . . 10] when there are 10 possible classes, while in a regression task a real number such as 1.3may be used, or a vector of real numbers such as (−0.26, 0, 1) may be used, etc.). y is sometimes referred to as ground truth. In classification tasks, y is commonly called the class label. If y can be either 0 or 1, y is commonly referred to as a binary label. It is noted that when an example (x,y) is presented to a neural network during training, x is presented in a way consumable to the network. The network's output (either directly or via interpretation) is compared to y, the loss value measuring the accuracy is computed, and model weights are adjusted based on the loss, immediately or after a batch of examples is presented and their cumulative average loss value is calculated. This scheme may have certain variations depending on the neural network's architecture and task.

Many training methodologies may use a variation of stochastic gradient descent (SGD) as an optimization component, for example, the Adam optimizer. Each time duration in which all training examples are presented to the model during training, is commonly referred to as an epoch, and usually training is made up of a sequence of some 1>0 epochs, E0, E2, . . . , El-1. Changes to the model weights may be applied after each training example is presented during training. Alternatively, as mentioned, a batch of examples is presented and after the whole batch is presented, weights are updated based on the batch's cumulative effect (e.g., the average of the cumulative loss of the batch's training examples).

For the case of size 1 batches, when a training example denote e_0 is presented to the neural network, weights of the neural network are updated accordingly. This weight change affects the loss of e_0 which captures the difference between its y values (i.e., ground truth) and the actual values computed by the neural network denoted ŷ. This weight change also may affect the loss of other examples if presented to the network in a feed forward no-training mode, i.e., just produce the output based on current model weights.

For a training example denoted e′=(x′, y′), its loss prior to the weight change is denoted 10 and after the change it is denoted 11. The net loss value change equals loss=(10-11); where the loss may be positive (respectively negative), i.e., the weight change decreased (respectively, increased) the loss of example e′, it may also be zero (i.e., no change in loss). This loss change of example e due to the presentation of example e_0 at time t may be denoted as lossChange(e, e_0, t) where t (intuitively, the time) indicates the number of times training examples were presented to the neural network prior to this presentation of e_0 (the first example overall that is presented is denoted t=0). totalLossChange(e_a,e_b) denotes the sum of all lossChange(e_a,e,_b,t) for t a time where e_b was presented to the network, t in 1, . . . , T, where T denotes the overall number of times examples were presented to the network during training. Similarly, totalLossChange(e_b) denotes the sum over all e_a in the training set (e_a=e_b is included) of totalLossChange(e_a,e_b). That is, totalAllLossChange(e_b) denotes the overall loss change over the whole training process and over all training examples that was induced by the presentations of training example e_b.

A recording taken at time t is denoted C_t and the final trained model M is also recording C_T. The recordings may be recorded along the training process. The recording may record the weights values at a certain recording time. Various data and meta data may be included within the recording, for example, learning rate, loss, accuracy, date and time, software versions used, human operator.

S denotes a subset, of cardinality denoted m, of the set of training examples. There may be additional training examples in the training set. The inter-loss matrix of S, denoted ILM(S), is a (m×m) matrix where the i,j entry ILM(S)_i,j is totalLossChange(e_j,e_i), i.e., the amount of loss induced throughout the training by presentations of e_i on the loss of e_j.

The scores totalLossChange(e_x) may be used based on the following observations:
(1) Low score examples may be good candidates for inspection (e.g., automatically or by a human) since as a group they contribute less in reducing the overall loss. This may be especially true for negative score examples that actually increased overall loss. Inspection may reveal mislabeled examples.
(2) Learning quality and generality may be preserved while eliminating examples e_x such that the absolute value of totalAllLossChange(e_x) is relatively “small”. Intuitively, the overall effect of such examples on the training process is small. This elimination may be useful in eliminating them from subsequent training (e.g., with additional new training examples) and may also result in unlearning, i.e., removing such example(s) and reducing, or eliminating, the effects of removed training examples on the model. Such unlearning may also be performed during training at an intermediate stage since this may accelerate training. It is noted that it may be possible for an example to be both in the group identified by (1) and the group identified by (2).
(3) The elimination procedure is usually costly (e.g., in terms of high processor utilization, long processing times, large memory requirements) as computing totalAllLossChange(e_x) for all e_x is O(square of the number of examples). Thus, rather than performing the computation for all examples e_x, the computation may be performed for examples e_x that are identified as consistently leading to very small weight changes when presented. A hash table or other suitable data structure may be used to track such examples. A hash table entry may include an example identifier and an associated counter that counts the number of times in which presenting this example had a negligible effect.

Referring now back to FIG. 3, a reduced training dataset may be created. The reduced training dataset created as described with reference to FIG. 3 may be used for training one or more models (e.g., neural networks) described herein. The reduced training dataset created as described with reference to FIG. 3 may include one or more training examples which are unlearned using one or more embodiments described herein.

At 302, multiple recordings may be recorded during training of the neural network on the training dataset. Recordings may be computed as described herein.

A recording includes weight values of the neural network at a time (and/or date) at which the recording is recorded.

The recording may be implemented as a checkpoint.

The recording and/or the checkpoint may further include one or more of:
A change in a loss function for a first training example induced by a change of weights of the neural network in response to a second training example. The first training example and the second training example are selected from multiple training examples of the training dataset. It is to be understood that the first training example and the second training example may refer to a single pair of training examples, or to multiple pairs of training examples (less than all of the pairs of training examples), or to all pairs of training examples.
A time (optionally including date) during the training associated with the change in the loss function.
Learning rate.
Value of the loss function.
Accuracy of the neural network.
Software version(s).
Human operator.

At 304, a total-loss of the change in loss function, e.g., denoted totalLossChange(e_x), is computed for each training example multiple times during the training, as described herein.

At 306, one or more training examples may be removed. The removal of the training examples creates a reduced training dataset.

Optionally, the training examples may be ranked according to respective changes in the total-loss function value of the neural network during training due to respective example, and/or in the total-loss. A subset of training examples having changes in the total-loss function value and/or in the total-loss function value below a threshold and/or meeting a requirement indicating low changes, may be presented on a display, optionally within a graphical user interface. Labels associated with each training example of the subset may be presented. A user may use the GUI to view the subset of training examples, and manually indicate whether a training example is to be maintained in the training dataset or removed from the training dataset.

In an example, the training examples denoted e_x are divided into three (or other number of groups based on their overall effects totalLossChange(e_x) on loss during training. Examples e_x may be sorted, from low to high, based on their total effect totalLossChange(e_x). The first 20% (or other value) in this sort order may be referred to as “low”, the middle 60% (or other value) may be referred to as “medium”, and the last 20% may be referred to as “high”. Low (resp., high) training examples overall contributed less (respectively, more) to decreasing the overall loss of the model. As such these low and high examples may be presented on a display, optionally within the GUI, for a user to inspect.

Optionally, the reduced training dataset is created by removing training examples having a value of the total-loss below a threshold. The total-loss may be summed over all the training examples. The threshold may be selected manually and/or automatically, for indicating values of the total-loss that represent irrelevant training examples that do not have a significant impact on accuracy of the model and/or that do not represent a significant gain in information during learning.

Examples of training examples that may be removed include:
Mislabeled example: a mislabeled training example may be removed from the training dataset.
Very similar examples: a training example including all of the following may be removed:
   An output feature of the training example that is close according to a requirement to an output feature of another example. In terms of mathematical representation: If two training examples e1=(x1,y1) and e2=(x2,y2) are such that (1) y1=y2 or y1 is very close (a threshold parameter) to y2, then example e1 can be eliminated.
   An input feature of the training example that is close according to another requirement to an input feature of the other training example. In terms of mathematical representation: o(x1) is within distance epsilon (a hyperparameter) to o(x2), where o(x) denotes the vector derived from the neurons that are inputs to a chosen layer that is among the last layers of the network prior to the logits units layer.
   There are at least a predefined number of training examples that are within a distance satisfying another requirement of intermediate network activation due to the input feature. The other requirements are computed for vectors computed from units that are inputs to a selected layer that is among last layers of the neural network prior to the logit units layer. In terms of mathematical representation: There are at least q (a hyperparameter) training examples e′=(x′,y′) (may be referred to as close neighbors) such that o(x′) and o(x2) are within a distance r*epsilon (r>0 denotes a hyperparameter).
   It is noted that different distance measures may be used, for example, Euclidean distance.
A non-contributing example (first type). The total-loss is computed for a sub-set of training examples for which presentation to the model during training leads to the change in the loss function value less than a threshold for multiple times. The number of the multiple times may be greater than another threshold. A training example having a number denoted q of close neighboring training examples with distance smaller than a distance denoted beta may be removed from the sub-set, where q and beta are hyperparameters. In terms of mathematical representation, if for all training examples e1, totalAllLossChange(e,e1) is less than beta (a hyperparameter), and e1 has at least q close neighbors, then e1 can be eliminated, as it contributes little to learning.
A non-contributing example (second type). If totalAllLossChange(e_a) is less than theta (a hyperparameter) and provided there are q close neighbors of e_a, then training example e_a may be removed.

At 308, features described with reference to 302-306 may be iterated, for reducing the training dataset by iterative removal of training examples. The removal of the training examples may be done before, during and/or after the training.

The removal of the training example may be according to one or more hyperparameters controlling how ‘aggressive’ the removal is. For example, a predefined number of training examples are to be removed and/or to be retained in the training dataset. The resulting reduced training set of examples may be designated as an essential set that is sifted out of the set of training examples.

During iterative removal of training examples, an accuracy of the neural network trained on the reduced training dataset may be computed. In response to the accuracy decreasing by an amount greater than a threshold (e.g., decreased by more than zeta percentage where zeta is a hyperparameter) in comparison to a previously computed accuracy, at least one of the removed training examples may be re-instated into the training dataset. This may catch and/or correct “overzealous” reduction of the training dataset.

At 310, a model (e.g., neural network, other machine learning model architecture) may be trained on the reduced training dataset.

Referring now back to FIG. 4A, at 402, recordings are recorded during training of the model (e.g., neural network) on the training dataset.

Recordings may be implemented, for example, as described with reference to 302 of FIG. 3.

At 404, an unlearning training example to unlearn from the neural network is selected and/or accessed.

At 406, a total-loss of a change in a loss function for training the neural network is computed for each of the multiple training examples. The change in the loss function is induced by a change of weights of the neural network in response to the unlearning training example.

The total-loss may be mathematically represented as TALC=totalAllLossChange(e_i).

At 408, one or more features are implemented according to the total-loss.

Optionally, a checkpoint to use to remove an unlearning training example is determined according to the total-loss.

Examples of features implemented according to the total-loss include:
Optionally, in response to determining that the total-loss is within a range indicating non-significant overall loss, the unlearning training example is removed. Examples are provided, for example, with reference to features 20 and/or 60 of FIG. 4B.
Alternatively, in response to determining that the total-loss is greater than a first threshold indicating the unlearning example significantly reduced overall loss during training, a recording with an increase in loss as compared to the latest recording greater than a second threshold is identified. The neural network is re-trained on an adapted training dataset that excludes the unlearning training example, as described with reference to 410. Examples are provided, for example, with reference to features 30 and/or 70 of FIG. 4B.
Alternatively, in response to determining that the total-loss is less than a second threshold indicating the unlearning example significantly increased overall loss during training, the neural network is re-trained from the most recent recording on an adapted training dataset that excludes the unlearning training example, as described with reference to 410. Examples are provided, for example, with reference to features 40 and/or 80 of FIG. 4B.
Alternatively, when none of the preceding conditions are met, the unlearning training example is removed. The neural network is subsequently trained on an adapted training dataset that excludes the unlearning training example. The neural network may be trained from the latest recording/checkpoint until the unlearning training example is sufficiently unlearned, for example, as described with reference to 80 of FIG. 4B. Alternatively, the neural network may be trained from a preceding checkpoint with increased loss until the unlearning training example is sufficiently unlearned, for example, as described with reference to 110 of FIG. 4B. The checkpoint may be selected based on the total loss, for example, as described with reference to 50, 90, or 100 of FIG. 4B.

Optionally, in the case of multiple unlearning training examples being removed. Different recordings may be selected. An earlier recording may require more training, more time, and/or more computational resources to be allocated and/or utilized. However, an earlier recording may provide better unlearning of the training examples being removed. The recording to use may be selected by examining history of overall model loss per recording, and selecting the recording that may provide for at least a defined percentage of improvement thereafter until the latest recording in terms of loss.

In terms of mathematical representation, a group of multiple training examples is denoted X. totalAllLossChange(X) is computed as the sum of totalAllLossChange(e_x) for all e_x in X. In continuing training after removal of the group, one of several available recordings may be selected. Generally, an earlier recording entails more training, more time and more computing costs. On the other hand, an earlier recording entails better unlearning of the effects of the removed example(s).

The history of overall model loss per recording may be analyzed (e.g., automatically by a process and/or manually by a user viewing the data on a display) for selecting a recording that allows for about K % improvement thereafter till the latest available recording in terms of loss. K is a parameter; for example 7.5 or other values.

At 410, the neural network is subsequently trained from the recording using the adapted training dataset excluding the unlearning training example(s).

At 412, an amount of information due to the unlearned training example that the model still retails post unlearning may be estimated.

The amount of information may be estimated by training a second neural network on a second training dataset of records. A record includes one or more of: a training example of the neural network, an example from a held out test set of examples that have not participated in training, another previously removed unlearned example, a loss computed by an unlearned neural network when presented with the unlearned training example, and a binary label (i.e., ground truth) indicating whether the unlearned training example is a training example, or a held out example, or a previously removed example. The unlearned example may be fed to the second neural network (i.e., for inference). In response to an outcome of the (inference by the) second neural indicating a training example, an indication that the removal of the unlearning example is insufficient may be generated. The indication may be provided, for example, presented on a display, and/or automatically fed into a feedback process for automatically removing additional training examples.

Additional exemplary approaches are described, for example, with reference to the in-spired method by Shokri, R., Stronati, M., Song, C., and Shmatikov, V., Membership inference attacks against machine learning models, found in the 2017 IEEE symposium on security and privacy (SP), pp. 3-18. IEEE, 2017, incorporated herein by reference in its entirety. The inspired method relates to training another model, denoted as MIA (the name eludes to its use in preventing a Membership Inference Attack), on a set of labeled examples of the form (e, loss, binaryLabel) where e denotes an example (e.g., from a held out test set or a removed example), loss is computed by the altered model denoted MNEW when presented with example e, and binaryLabel=0 if e is a test or held out example and 1 if it is a removed example. Once MIA is trained it may be tested on a removal test set that includes yet another set of held out test examples and held out unlearned examples not participating in training MIA. The unlearning may be considered fully approximate if MIA's accuracy is close to 50%. A threshold may be set (e.g., by a user and/or predefined and/or automatically selected), for example, a 55% accuracy or other value, to consider the removal acceptable and otherwise may decide to retrain the model from scratch.

The aforementioned approach may be bootstrapped. A set of examples that were actually unlearned may be accessed in order to evaluate the model post unlearning of a set of original training examples. An exemplary method of producing such a set is as follows: At the outset, in addition to training, test and validation sets, two additional sets of examples are created. One set includes yet another set of held out test examples for use in training MIA. The other new set is a set of training examples that will be used during training and then unlearned once training is complete. After the unlearning, the model will be altered to reflect the unlearning and loss values for training MIA may be obtained. MIA may then be trained and unlearning effectiveness may be ascertained. MIA may be continuously trained and/or evaluated later on as additional examples are removed.

Referring now back to FIG. 4B, the features described with reference to FIG. 4B may be implemented based on, and/or combined with, and/or serve as alternative to, the features described with reference to FIG. 4A. In an exemplary embodiment, the features described with reference to FIG. 4B represent an exemplary implementation of the method described with reference to FIG. 4A.

At 10, one or more of the following may be provided: training examples used to train the model, example e_i to be unlearned (removed), a trained model, and model recordings.

At 15, TALC=totalAllLossChange(e_i) is calculated. Branches 20, 30, 40, or 50 are selected according to the value of TALC. The regions of values addressed by branches 20, 30, 40, and 50 may be follows (it is noted that that there are multiple possibilities for the location of 0 which are not indicated): [−∞, E) [E, C)[C, B] (B, D] (D, +∞].

At 20, C≤TALC≤B (hyperparameters: positive B and negative C).

At 60, e_i may be unlearned and/or removed from the training dataset with probability p (p is a parameter, e.g., 1.0, 0.87). The rationale, is that overall e_i had little effect on overall loss.

At 30, TALC>D≥B (D a hyperparameter) indicating significantly reduced overall loss. e_i is unlearned and/or removed from the training dataset according to 70.

At 70, access a recording denoted Ch with increased loss at least Delta˜(mue×D), where mue is a hyperparameter. The recording Ch is expected to be in the fairly recent past. This may be because totalAllLossChange(e_i) is expected to be a small value since e_i is a single example among usually many thousands. Train from that recording Ch onwards over all the other training examples (may optionally reset the learning rate) until e_i is sufficiently unlearned or allotted time (a parameter) is exceeded in which case indicate failure to unlearn e_i.

At 40, TALC<E≤C (E is a parameter) indicating significantly increased overall loss.

At 80, train from the latest recording on all other training examples, i.e., remove e_i from the training dataset (may optionally reset the learning rate). A possible rationale is that it may be possible to drive the overall loss down following the removal. This is possible if e_i contributed significantly to the loss.

Otherwise at 50, erase e_i with probability p1 (p1 is a parameter e.g., 1.0, 0.95, 0.5).

At 90, when TALC<C, implement feature 80.

Alternatively, at 100, when TALC>B, implement feature 110 which corresponds to feature 70.

Referring now back to FIG. 5A, it is noted that the method described with reference to FIG. 4A is based on the effects of a removed example e_x on the overall model learning quality. In the method(s) described with reference to FIG. 5A, the influence of a removed training example e_x is first checked on each and every other example. Assume, without loss of generality, that x=0, i.e., e_x is training example e_0, and the rest of the training examples are numbered 1 through n (a total of n+1).

At 502, recordings are recorded during training, for example, as described with reference to 402 of FIG. 4A.

At 504, an unlearning training example to unlearn from the neural network, is selected.

At 506, a weight c_i is assigned to each of the training examples e_i, for i=0, . . . n, wherein n is the number of training examples.

Optionally, the weights are computed by solving a linear equation of a form M*Q=−J, where Q denote a column vector of variables, M denotes a matrix of n squared entries, the M_im entry is a total loss influence of a training example i on a training example m, and J denotes a column vector. The m'th entry denoted J_m is the total-loss-change of training example denoted e_m due to the unlearning training example. The linear equation is solved for the variables, using each variable to adjust each corresponding weight of a corresponding training example.

At 508, per checkpoint, a total-loss-change parameter may be computed as an overall loss reduction effect of the unlearning training example on a different training example.

Optionally, a value of a current weight of a certain training example may be defined as a value of the current weight plus a variable-parameter multiplied by an absolute value of the total-loss-change parameter for the certain training example divided by the sum of absolute values of the total-loss-change parameter of all the training examples. Alternatively, the value of the current weight of the certain training example may be defined as a value of the current weight minus a variable-parameter multiplied by the value of the total-loss-change parameter for the certain training example divided by the sum of absolute values of the total-loss-change parameter of all the training examples.

A value of the total-loss-change parameter>0 may indicate loss reduction for a certain different training example due to the unlearning training example. A value of the total-loss-change parameter<0 may indicate loss increase for the certain different training example due to the unlearning training example.

The loss reduction calculations (i.e., total-loss-change) may be intertwined with the weight updates calculations during training. For example, as described with reference to Garima Pruthi, Frederick Liu, Mukund Sundararajan, Satyen Kale: Estimating Training Data Influence by Tracking Gradient Descent. CoRR abs/2002.08484 (2020), which describe various ways for computing TracIn(example1, example2) which approximates the loss of example2 induced by example1. A summary of the TracIn method is provided herein.

At 510, per checkpoint, a total sum of values or of absolute values of the total-loss change parameter is computed for the training examples.

When the total sum of values includes the total sum of the absolute values, and in response to the total sum exceeding a threshold, the total sum may be adjusted according to the threshold.

A weight may be assigned to each of the training examples.

At 512, the weight of each training example may be used to modify its impact on loss during further training to account for the removal of the unlearning training example on each of the training examples' associated loss. The further training may be computed from a preceding recording and/or from a current recording forward.

Optionally, in further training, the weight of each training example is increased in proportion to a magnitude of a loss of the training example due to the unlearning example relative to a sum of the magnitudes of loss of the plurality of training examples due to the unlearning example.

At 514, the neural network with the adapted weights is subsequently trained from the recording using the adapted training dataset excluding the unlearning training example(s).

A past or current recording is selected (the exact choice may be based on a balance between computational cost and expected quality) and from training the model from the selected recording onwards utilizing the adapted weights. The model is trained until it can be determined that e_0 is sufficiently unlearned (e.g., designated as success) or a combination of the allotted real clock time, or computing time, or budget, e.g., in USD (all are parameters), is exceeded (e.g., designated as failure).

The method described with reference to FIG. 5A may be generalized to unlearning a set denoted X of training examples. In such implementation J_m denotes the sum over all e_0 in X of totalLossChange(e_m, e_0), 0≤m≤n, i.e., the overall loss reduction effect of examples in X on example e_m. A threshold denoted th may be defined such that once the cumulative effect on loss of removing the examples in X exceeds the threshold th, features described herein are implemented for the set of examples X removed since the last time removal adjustments were performed. Referring now back to FIG. 5B, the features described with reference to FIG. 5B may be implemented based on, and/or combined with, and/or serve as alternative to, the features described with reference to FIG. 5A. In an exemplary embodiment, the features described with reference to FIG. 5B represent an exemplary implementation of the method described with reference to FIG. 5A

At 200, one or more of the following may be provided: training examples used to train the model, example e_0 to be unlearned (removed), a trained model, and/or model recordings.

At 210, the J_m values are computed.

At 220, a method for computing amplification coefficients, denoted c_i, is selected from available methods, also denoted methods 1, 1′, 2, 2′, and 3 (described below), is selected. For example, the user manually selects the method, or the method is automatically selected such as by a trained classifier, set of rules, and the like.

At 230, c_i is computed for i=0, . . . n, according to the selected method.

At 240, a checkpoint denoted Ch from which to continue training, is selected.

At 250, training continues from the selected recording Ch with c_i amplifying the loss when presenting e_i, i=1, . . . , n, until e_0 is sufficiently unlearned (i.e., success) or allotted resources are exceeded (e.g., failure).

Additional implementations based on the methods described with reference to FIGS. 5A and 5B are described. The additional implementations are described using mathematical representations.

Let J_m=totalLossChange(e_m, e_0), 0≤ m≤n, i.e., the overall loss reduction effect of example e_0 on example e_m. J_m>0 indicates loss reduction for e_m due to example e_0, and J_m<0 indicates loss increase for e_m due to example e_0. The J_m values may be computed based on the model recordings taken along the training process. The cost of computing J_m is linear in the number of training examples.

A weight denoted c_i is associated with each training example denoted e_i. Initially c_i=1 for all i. Conceptually, it is desired to increase or decrease the weight c_i of each example e_i. When a loss is computed when presenting the example e_i, the loss is amplified by its weight. The c_i's are chosen so as to account for the removal of example e_0 on each other example e_i's associated loss. This applies (e.g., only) to computing from a previous recording, or from the current recording forward, according to the implementation. There may be a progressive “decay” parameter that will bring the c_i's values back to 1 as further training goes forward.

An exemplary implementation referred to herein as Method 1 is now described in terms of mathematical representation: Let Total be the sum of the absolute values of all J_m. Let c_i=c_i+R*(|J_i|/Total) where R>0 is a parameter and |·| is absolute value. The rationale is to increase the weight of a training example e_i in proportion to the magnitude of the loss of example e_i due to e_0 relative to the sum of the magnitudes of the losses of all examples (that are due to e_0). This is regardless of whether e_0 overall contributed to increasing or decreasing the loss of e_i.

This provides “extra influence” on the training process to examples that were “affected” most by the removed example e_0 during training and thereby allows to “adjust” their loss.

Similar to Method 1, Method 1′ may be defined where Total is the sum of all the J_m values (not their absolute values), if not zero; if |Total| exceeds a threshold th, it may be adjusted (Total/|Total|)*th.

Another exemplary implementation referred to herein as Method 2 is now described in terms of mathematical representation: Let Total be the sum of the absolute values of all J_m. Let c_i=c_i−R*(J_i/Total) where R>0 is a parameter and |·| is absolute value; note that J_i is used here rather than |J_i| as in Methods 1 and 1′. Also note the use of minus rather than plus. The rationale is as follows:
1. If J_i is positive e_0 reduced the overall loss of e_i. The analysis for J_i<0 is similar.
2. Had e_0 been absent, the loss of e_i would have been increased.
3. When e_i is presented to the network during training, it usually reduces its own loss the most.
4. Therefore, there is a need to decrease the effect when presenting e_i so as to cause some loss increase to account for the fact that e_0 is been removed.

Similar to Method 2, Method 2′ may be defined where Total is the sum of all the J_m values (not their absolute values), if not zero; if |Total| exceeds a threshold th, it may be adjusted (Total/|Total|)*th.

Another exemplary implementation referred to herein as Method 3 is now described in terms of mathematical representation: The c_i's are computed by solving a linear equation of the form M*Q=−J where:
Q is a column vector of variables q_1, . . . , q_n.
M is a matrix of n squared entries, wherein n denotes the number of training examples.

The M_im entry is the total loss influence of example e_i on example e_m, namely totalLossChange(e_m,e_i). Note that this computation takes O(n squared) time which may be significant.
J is the column vector J_1, . . . , J_n.

The equation for the variables q_1, . . . , q_n is solved, q_i is used to adjust the weight c_i of example e_i, 1≤i ón, c_i=c_i+R*q_i, where R>0 denotes a parameter.

Each e_i, 1<is n, has a “loss budget” (−J_i) to allocate to all the examples. Suppose J_i<0 (the case J_i>0 is analogous). This means e_0 increased the overall loss of e_i. Now that e_0 has been removed e_i may be allowed to more effectively reduce its loss. Thus, its “loss budget” is positive. Allocation may be done so as to increase loss reduction for e_i (since e_0 increased the overall loss on e_i). The technical challenge is how to divide (−J_i) among the examples as weights. It is noted that there is a balancing act in dividing the budgets among the examples.

As computing an n squared matrix M may be costly, the u examples (where u is a parameter) may be treated with significant J_m values and the rest may be ignored.

The value of totalLossChange (e_i,e_j) and/or other loss quantities may be approximated using one of the TraceIn methods (e.g., as described below). Note that if M*Q=J does not have a solution, M and Q may be “regularized” to obtain an approximate solution.

Unlearning may also apply to hypothetical training examples. Consider a hypothetical training example denoted e_h. To unlearn e_h, pretend e_h is a regular training example used in training. Using recordings, a calculation is done to determine what would have been the effects of e_h on other examples had it been present during training. Based on this calculation the unlearning methods may be applied to e_h. This technique may be useful in manipulating models during and after training.

Referring now back to FIG. 6A, at 602, a text element for unlearning is accessed. The text element is represented by multiple tokens.

In terms of mathematical representation, a piece of text denotes as t0 and represented as t_01, . . . ,t_0m, is to be removed in the context of an LLM model built over texts. t_01, . . . , t_0m are tokens, i.e., representing words or sub-words.

Optionally, before removing t0, it may be ascertained that t0 does not appear as another piece of text, or embedded within another piece of text used to train the LLM. If t0 appears as or in multiple texts, removing t0 may not be sufficient and there may be other texts that need be removed as well. Determining whether the text element appears in other training examples can be done by accessing vector embeddings of text training examples and/or portions thereof used to train the generative model. For example, using a text to vector process. A text vector embedding of the text element is computed. The text vector embedding of the text element may be searched within the vector embeddings of the text training examples, for example, for close matches such as by smallest distance (e.g., Euclidean distance) and/or by highest correlation values. Vector embeddings in proximity to the text vector embedding may be identified. If the text element is found, unlearning may be performed by a whole text training example corresponding to identified vector embeddings, and/or for a sub-text of the whole text training example including the text element, and/or retaining the whole text training example without unlearning.

In terms of mathematical representation, in case the text to be removed, t0, is also embedded in another text denoted t1, there are a number of options (e.g., user decided or probabilistically chosen): (1) apply the same unlearning process to t1 as a whole, (2) apply the unlearning process only to the sub-text of t1 that is highly similar to t0, (3) leave t1 as is, the rationale is that the unlearning process applied to t0 and highly similar texts will diminish the model's knowledge manifested in the part of t1 that is highly similar to t0, and (4) choose probabilistically among options (1), (2) and (3).

At 604, multiple text training examples are generated. The text training examples may be generated by changing a token or a series of contiguous tokens by replacing the token or the series by another token or another series of tokens, for example, by randomly selecting among candidate tokens with a probability above a threshold according to the generative model prediction on the text element when the token or the series of tokens is masked away from the LLM.

In terms of mathematical representation, a number (e.g., large number) denoted n (e.g., a hyperparameter) of texts denoted t1, . . . , tn, is generated. The texts are generated by changing a token denoted t_oi (1≤i≤m) or a sequence of contiguous tokens denoted t_0i, t_o(i+1), . . . , t_0(i+k) in t0 ((1≤i+k≤m), k is a parameter, whose values may be randomly drawn each time from a specified probability distribution. The change is that of replacing a token or a tokens sequence, by a token or a tokens sequence, where tokens are randomly chosen among tokens with a probability above epsilon (a hyperparameter) according to the LLM prediction on to when the t_0i token or the sequence t_0i, t_o(i+1), . . . , t_0(i+k) is masked away from the LLM model.

At 606, the LLM is trained on the text training examples to create an adapted LLM for which it is determined that the text element has been sufficiently unlearned.

The n text training examples may be used to continue training and/or to modify the LLM model into a new model denoted LLM1. This may be done by continuing training of the model using these n text training examples until such time that it can be determined that the text to is sufficiently unlearned.

At 608, an evaluation may be performed for determining that the text element has been sufficiently unlearned by the LLM.

Optionally, for each presentation of the text element and each of the text training examples presented separately to the LLM excluding masking, a distance between the LLM's prediction and the presentation to the LLM may be computed. The text element and each of the text training examples may be listed according to an increasing (or decreasing) distance. The distance may be implemented as a number of mis-predicted tokens. In response to the text element being excluded from an initial portion of the list satisfying a requirement indicating a small distance, it is determined that the text element has been sufficiently unlearned by the LLM.

Optionally, a point in time in which sufficient unlearning took place is identified.

In terms of mathematical representation t0 and each of the n text training examples are presented, separately, to the model with no masking. In each presentation the distance denoted D_e between the model's prediction of text and the text that is presented to the model may be computed. The distance can be implemented as the number of mis-predicted tokens. Other distance measures may be used. The n examples t0, t1, . . . , tn may be listed in terms of distance from low to high. A location early in the list indicates that the model's prediction is closer to the presented example. If t0 is not among the first (1/m), m>0 is a parameter, on this list, to may be considered as sufficiently unlearned, where m may be a hyperparameter. For example, if m=3 and to is not among the first n/3 texts on the list, then to is considered sufficiently unlearned.

Optionally, the LLM has been previously trained using a non-supervised approach, optionally on a vast amount of data.

Alternatively, the LLM is implemented as a fine-tuned pre-trained LLM model trained with labelled data. The approach for unlearning in such implementation is similar to unlearning in an “ordinary” model trained in a supervised manner. To clarify, the fact that the current model evolved from an earlier LLM by utilizing or extending its architecture and weights does not change the general setting. This is true even if portions of the pre-evolved model's weights are held static or are constrained in the amount of change that may be applied to them during refinement.

Alternatively, the LLM is implemented as a fine-tuned LLM model trained using an unsupervised approach. The token or series of tokens that is replaced is used in the fine tuning, for example, the next token following a sequence of tokens.

Alternatively, the LLM is implemented as a chatbot. The unlearning in the implementation of the chatbot, is technically challenging since there may be no access to the internals of the chatbot's model, or models, that underline its operation. In such a case, the only access that may be available may be through prompts presented to the model. It may be possible to request the chatbot to unlearn a text within a prompt. In such implementation, the chatbot may ascertain that the request to unlearn is legitimate; this may involve for example, identifying the requesting user and presenting an argument to the chatbot, within the prompt, for the requested unlearning. Another technical challenge is determining whether this unlearning applies only to the requesting user or has a global effect on all users. This is a decision that the chatbot provider may be required to make.

Another plausible scenario is that a request to unlearn will apply locally (to the session or user making the request) but global unlearning will happen gradually as more and more users and sessions request it. One exemplary implementation is as follows: The chatbot continuously learns and unlearns from its multiple interactions with users prompts. In this implementation, it may be indicated repeatedly, optionally by multiple users, that a piece of text is to be unlearned, for example, since the text is imprecise or undesired for some other reasons. In its continuous learning the chatbot underlying model may gradually unlearn the piece of text and similar and/or embedding texts as more and more requests to unlearn the piece of text are encountered.

Alternatively or additionally, the LLM model is implemented as a generative model for generating images. The text element is obtained by an image-to-text conversion process in which image data is pre-processed (e.g., using computer vision approaches and/or image processing approaches) to extract features and/or information from the image which is described as text. This text representation of the image can be fed into the LLM model for further processing. Unlearning an image denoted im applies to the textual description denoted t_im associated with the image. That is, to make the model unlearn the image it unlearns the textual description of the image.

Alternatively or additionally, the LLM model is implemented as a hybrid model that combines both text and image processing capabilities. It's capable of generating textual descriptions for images and also ranking images based on textual prompts. Such model may be capable of generating textual descriptions for images and also ranking images based on textual prompts.

Alternatively or additionally, the LLM model is implemented using multimodal approaches in which models can handle both text and image inputs in a single framework. These models aim to capture the relationship between text and images more closely. In such a model, an input includes text and an image.

Referring now back to FIG. 6B, at 650, one or more of the following may be provided: a value for n indicating a number of training examples used to train the model, example of text element denoted t_0 to be unlearned (removed), a trained model, and/or model checkpoints.

At 652, the text t_0 to be unlearned is divided into a token sequence denoted t_01, . . . , t_0m.

At 654, n texts are produced by replacing a token or token sequence with a randomly selected token or token sequence. This generates n new “misleading” text examples.

At 656, the text to be unlearned may be located in other occurrences. New “misleading” example texts may be created.

At 658, the generative model is trained on the new misleading examples to adjust the model's weights to unlearn the text to be unlearned.

Referring now back to FIG. 7, at 702, an image for unlearning by a generative model is accessed.

The image includes cells, each of which includes one or more pixels. Each pixel may include one or more channels, for example, defining black and white images, colored images (e.g., in a red-green-blue (RGB) space and/or other space), and others (e.g., multi-spectral).

In terms of mathematical representation, an image may be represented as a tensor of (a×b) cells. Each cell may represent a pixel, and is associated with values for one or more channels. For the sake of simplifying the description, assume a single channel denoted B.

At 704, multiple image training examples are generated.

The image training examples may be generated by selecting continuous regions in the image to be unlearned. For each region, a number of cells for inclusion in the region may be selected. A number of cells selected for inclusion in the region is selected from a range of 1 to a total number of cells in the image divided by a hyperparameter less a total number of cells already selected in at least one other region.

Intensity of the channel(s) of pixels of cells of the region may be adapted, for example, randomly and/or based on an automated process.

In terms of mathematical representation, the image to be unlearned is denoted as im_0. The new images generated from the image to be unlearned may be generated as follows: the number of images to be generated is denoted N. The i'th image is modified by selecting a number of regions in the image to alter. The number of regions may be up to a value denoted as q. The number q may be selected, for example, randomly and uniformly, and/or out of a probability distribution, over the range denoted [1, . . . (a×b)]. A region may be a connected set of cells such that two cells denoted (x1,y1) and (x2,y2) are connected if they are neighbors, i.e., either x1=x2 and |y1−y2|=1 or y1=y2 and |x1−x2|=1.

As long as there are available cells (i.e., the cells not yet chosen for any region), a new region may be generated follows: The number of cells in the region, denoted NS, may be selected (e.g., randomly and uniformly, out of a probability distribution) in the range [1 . . . ((a×b)/H)−number_unavailable_cells)], where H denotes a hyperparameter and number_unavailable_cells denotes the number of cells already chosen for some region. The cells of a region may be selected among the available cells (i.e., not yet chosen).

A region may be created by selecting a seed cell among available cells that are candidates for inclusion in a region. The feature of ‘an available cell neighboring the region, to add to the region, may be selected’, may be performed in multiple iterations until no available cells remain and/or the region has reached or exceeds a predefined maximum number of cells, and no new cell can be added to the region. The selected cell is added for inclusion in the region that neighbors the selected cell. The regions may be selected such that the (optionally all) cells of the image are included in at least one region of the multiple regions.

In terms of mathematical representation: a seed cell is chosen randomly among the available cells and it initializes the set of cells of the region. The following steps are iterated as long as there are available cells, and the region has less than NS cells, and one of the steps can add at least one new cell to the region:
1. A cell in the region such that it neighbors an available cell is selected, for example, uniformly and randomly and/or using a distribution.
2. If there are L neighboring available cells to the chosen cell then up to u (where u denotes randomly and uniformly chosen value in the range [1 . . . L], where L is a parameter) cells are added to the set of cells in the region while not exceeding NS.

Each region denoted r is altered by uniformly choosing a random value for the number describing channel B.

In summary, the modified image is obtained from the original image by selecting a number of contiguous regions of cells, each with a number of cells that is randomly chosen, and modifying the intensity of R, G and B (in general) for the regions' cells (pixels). For a hybrid model that process a combination of text and images, for removal of a training example that includes a combination of a text component and an image component, after generating n texts to replace the text component, and generating N images to replace the image component, (n×N) text-image pairs may be generated. These pairs may be used for continuing training of the model for unlearning of the original text and image pair. Optionally, in a pair, the text component may be replaced by the original text. Optionally, in a pair, the image component may be replaced by the original image.

At 706, training of the generative model may be continued on the image training examples with modified regions to create an adapted generative model. The training may terminate (i.e., continue until) it is determined that the image has been sufficiently unlearned by the adapted generative model.

Referring now back to FIG. 8, at 802, one or more hypothetical examples may be generated.

The hypothetical examples may be created after at least two recordings have been recorded. The following is an exemplary approach for creating the hypothetical examples: Multiple clusters are created. A cluster includes training examples based on the neural network's vector embedding of a training example that is implied by a current state of the neural network being trained. For each cluster, at least one training example input part is selected. At least one hypothetical example is derived for each candidate label from the training example input part(s) (for example, the hypothetical example input x may be computed as a function (e.g., aggregation such as average, median, and the like) of x1, . . . , xm, wherein xi denotes the input part of an example in the cluster). Gradient vectors are calculated for the hypothetical example for each subsequent time a recording is recorded. The gradient vectors for the new hypothetical training example may be computed in a feed forward only mode without learning. The gradient vectors may be computed prior to inference of the input by the neural network. The calculated gradient vectors of the hypothetical training example are used for computing a dot product for identifying the unlearning training examples likely correlated with the input of an example leading to the faulty prediction during inference that is to close to the hypothetical example input part and having an identical label to it.

The hypothetical examples are produced ahead of debugging a false prediction. The idea is that an example generating a false prediction at deployment time is likely close (various measures of closeness may be applied here) to one of the hypothetical examples. We use the gradient of the closest hypothetical example, thereby the gradient for the debugged example is effectively computed approximately prior to deployment. So instead of using the “false prediction example” itself, debugging may be started by using the close hypothetical relative.

During the inference, a gradient vector of a hypothetical example closest to the input-caused gradient vector may be found based on the gradient vectors of the hypothetical example and the input. For example, by performing a vector search for locating a highest dot product hypothetical example gradient vector. At least one training example most influential in reducing a loss of the hypothetical example associated with the highest dot product, may be identified.

Additional details are now presented:

An exemplary approach for tracking loss reduction that presenting the model with an example denoted e during training causes for other examples is TracIn, as described with reference to Garima Pruthi, Frederick Liu, Mukund Sundararajan, Satyen Kale: Estimating Training Data Influence by Tracking Gradient Descent. CoRR abs/2002.08484 (2020), incorporated herein by reference in its entirety.

An exemplary approach for fast determination as to which training examples influenced the observed model output for a deployment time (also referred to herein as inference) example is that of performing the dot product between two gradient vectors with respect to weights of the last fully connected layer of the model upon being (1) presented with a training example and (2) upon being presented with a deployment time example. The technical problem is that it is time consuming to perform the TracIn calculation for the deployment time example, since the TracIn method entails examining recordings and performing a dot product between many pairs of gradient vectors. This calculation is performed because deployment time examples are not known in advance. Therefore, their associated gradients cannot be calculated at training time.

To mitigate the aforementioned technical problem, at a point in time when a recording Ch is recorded, after a few recordings have been already taken during training, hypothetical examples (also referred to herein as hypothetical deployment time examples) are created. The examples are clustered based on the model's vector embedding of an example that is implied by the current state of the model being trained. For each cluster denoted C, a number denoted m of examples input parts x1, . . . , xm are accessed. New examples (x, y_i) are derived from the example input parts of the cluster, for each possible label i from these m input parts (for example, x may be the average of x1, . . . , xm). The gradient vectors are calculated for these m new examples (in a feed forward only mode without learning) for each subsequent time a recording is taken. These gradient vectors are used in TracIn's dot product calculations with the gradients associated with the training examples. The total number of hypothetical examples is a parameter. For completeness, the calculation of these gradient vectors is performed for the previous recordings (before Ch).

Using this approach, even before deployment time, the relevant gradient vectors are pre-computed. Therefore, in deployment time (i.e., inference) the gradient vector of a hypothetical example may be quickly identified. A vector search may be quickly performed for locating the most affecting (i.e., highest dot product) real examples gradient vectors. This computation maybe performed prior to deployment.

At 804, a prediction of the neural network in response to an input is monitored, for detecting a faulty prediction in disagreement with an expectation for the input.

At 806, the unlearning training examples likely leading to the faulty prediction are identified.

The unlearning training examples (those causing misprediction) may be identified by computing the dot product between a gradient vector of weights of at least one layer of the neural network during training using training examples. The dot product and/or the gradient vector of the layer may be computed in response to the neural network being fed the input. The unlearning training examples may be identified according to a highest value of the dot product, i.e., the unlearning training example associated with highest value of the dot product.

Additional details are now presented:

During deployment time, given a new input example denoted (w, y), the hypothetical example denoted (x, y) such that x is closest to w (based on the vector embeddings of these two examples, implied by the activations of the chosen units' layer of the model for creating embedding vectors), is found. To estimate which of the examples reduce/increase the loss of (w, y) the most when (w, y) is presented (i.e., w is the input and the loss is based on comparing the model's output to y) to the trained model, the (real) training examples that reduce/increase the loss the most of the hypothetical example (x, y) (which are already pre-computed) may be presented on a display, for viewing by a user. The training examples most influential in reducing the loss on the (close to (w,y)) hypothetical example (pre-computed) instead of performing the calculation during deployment time on the actual input example and predicted label, are presented.

It is noted that the TracIn methods are approximations and that the embodiments using hypothetical examples descried herein may introduces yet another approximation. Thus, when presenting the results on a display (e.g., to the user), the display may indicate that this is a further approximation. An option of generating the presented training examples based on the more precise TracIn (original) approximation (which also may be executed in parallel as a default) may be provided. It is noted that searching for the closest training example involves a nearest neighbor vector search in a vector repository, which may be yet one more (fast) approximation.

At 808, the unlearning training examples may be unlearned from the neural network, optionally using one or more embodiments described herein.

Optionally, an average of a learning rate between neighboring recordings is used for the unlearning.

Optionally, a certain training example is presented to the neural network at least two times between two recordings. A number of times each training example is presented to the neural network between recordings may be monitored.

Additional details are now described:

Two more improvements over the TracIn method are provided. In the paper describing TracIn it is stated that “We assume that within recordings each example is visited exactly once”. In contrast, at least one embodiment described herein allows a test example to be presented more than once between recordings. This may be done by keeping a counter A of dimension n (n denotes the number of training examples). A [i] denotes the number of times example e_i had been presented since the last recording. For all i, A [i] is reset to 0 after each recording is taken. This counter may help in better estimating the influence on the loss of each example between recordings.

Regarding the learning rate, in the paper describing TracIn it is stated that “While the first order approximation . . . approximate with the first recording parameter after it”. In contrast, at least one embodiment described herein uses the average learning rate between the two neighboring recordings. This approach may make the approximation more precise. This approach may imply keeping a history of learning rates between adjacent recordings.

Referring now back to FIG. 9, the pseudocode for debugging a model that generated a faulty prediction, is presented. This code is designed for the general operating principles of debugging described herein. Variations in the flow of control and/or implementation of other features may be adapted.

Other error measures are now described:

AUM is the cross-epoch average of the model uncertainty for each data sample (calculated as the difference between the ground truth confidence and the maximum confidence on a non-ground truth label). To calculate AUM during training, for each example z=(x,y) and each epoch denoted t, the difference denoted M between the ground truth confidence and the maximum confidence on a non-ground truth label may be calculated. In terms of mathematical notation, this is denoted as M^{(t)}(x, y)=z_{y}^{(t)}(x)−max_{i≠y} zᵢ^{(t)}(x) where zᵢ^{(t)} (x) denotes the model's logit corresponding to class i-pre-softmax output.

It is noted that this calculation may be approximated by calculating over model recordings and then averaging. The approximation enables integrating this and similar measures into locating training examples that are potentially mislabeled based on model recordings. If more than one measure ranks an example high, it increases confidence that it is in fact mislabeled. For example, if both self-influence, namely a high TracIn(e,e) score as well as high AUM score increases the likelihood that the example e is mislabeled. On the other hand, a moderate score according to one measure and a low one according to another measure, reduces this likelihood. There are known approaches for obtaining a single ranking from 2 or more distinct rankings that may be used, for example, as described with reference to R. Fagin. Combining fuzzy information from multiple systems, and/or R. Hull, editor, Proc. ACMSIGMOD/SIGACT Conf. on Princ. of Database Syst. (PODS), pages 216-226, Montreal, Canada, 1996. The Association for Computing Machinery, incorporated herein by reference in its entirety.

The TraceIn method is now briefly discussed.

The TracIn method is described in the context of classification tasks trained via Stochastic Gradient Descent (SGD) and may be adapted to variants thereof. There is a finite set of classes (e.g., “healthy”, “sick”, “unclear”). Each training example is labeled by the class (e.g., “healthy”) the user assigns to this example. In training a model denoted M via SGD, a presentation of a training example denoted e generates an output. The difference between this output and the label of e induces a change in the model parameters (weights).

TracIn is a method for quantifying the influence of a training example on a prediction of a model on a specific example. This attribution to training examples contrasts with attribution to specific features (that appear in all training examples) or specific to the model architecture and parameters. Example e may be any labeled example, example e may belong to the training set, the validation set, the test set, or be a deployment time example. Example e may or may not be known at training time.

When example e is presented to the model, a prediction is generated. The difference between the label of e and the prediction of the model induces a loss value, or simply loss, that quantifies this difference.

Consider an example e, a training example denoted f, and a model denoted M. The output of TracIn computes a score that measures the influence of f on the model M prediction on example e. If the score assigned to f is smaller (respectively, larger) than the score assigned by TracIn to training example g (regarding e), then f is less (respectively, more) influential than g per the loss of M on e.

Consider an idealized situation in which example e is known at training time. Let Le_0 be the loss of e when presented (for prediction only and without model modification) to M before training starts, i.e. at time t=0. Consider now presenting, one at a time, the training examples, at times t=1, . . . , n. Denote by e_t the training example presented at time t. After the presentation of example e_t the weights of the model are updated from w_t to w_(t+1).

Before each training example presentation at time t, compute the loss Le on e when presented to M (again, without training) and denote this loss by Le_t. Consider any training example f. The score of training example f with respect to e, Score_e_f, is the sum of De_t=Le_t−Le_(t+1) for all times t in which f is the example presented at time t, i.e., e_t=f. Intuitively, De_t measures the reduction of the loss of the model M on e due to the training step t. Observe that De_t may be positive (loss reduction), zero (no change) or negative (loss increased). If Score_e_f>0 (respectively, Score_e_f<=0) then example f is called a proponent (respectively, opponent) of M predicting the label of e when presented with e for prediction.

By a first order approximation, using the gradient of Le with respect to model's parameters at time t, ∇Le_t, and the difference weight vector (w_(t+1)−w_t), Le_(t+1)=Le_t+∇Le_t*(w_(t+1)−w_t)+O(∥w_(t+1)−w_t∥\hat{ }2), where ∥·∥ denotes length, which implies that approximately Le_(t+1)=Le_t+∇Le_t*(w_(t+1)−w_t). However, (w_(t+1)−w_t) is the model weight change due to the presentation of f=e_t, which in turn is the product (−η_t*∇Lf_t) where η_t is the learning rate at time t, thus (w_(t+1)−w_t)=(−n_t*∇Lf_t). Therefore, Le_(t+1)=Le_t+∇Le_t·(−n_t*∇Lf_t) implying that Le_t−Le_(t+1)=∇Le_t·(η_i*∇Lf_t)=η_t*∇Le_t·∇Lf_t. Here · denotes vector dot product.

As described, the TracIn method is problematic as usually e is not known ahead of training and the abovementioned calculations need be done at deployment time. There are other problems, for example, often examples are not presented one at a time during training but rather they are presented in batches. Therefore, an approximation is used. There are a few exemplary approximation schemes, each one trading efficiency for preciseness. The first one is based on recordings collected during the training process. A recording (or checkpoint) may be a “dump” of all the model's parameters (weights and other components) at a point in time. The frequency and way in which recordings are generated trade off efficiency, cost and storage for preciseness. The collection of recordings may be viewed as a “sampled” summary of the model evolution during training.

Now, rather than computing Score_e_f by summing De_t over all times t in which e_t=f, the computation is over all recordings w_t1, . . . , w_tk taken at times t1, . . . , tk. For the learning rate, the learning rate at time ti is used, and it is assumed that each training example denoted f was presented exactly once in training between time-adjacent recordings. This is a simplifying assumption. However, this approximation is justified because usually if Score_e_f>Score_e_g by the previous calculation, this still holds when evaluating by summing over recordings.

TracIn can identify mislabeled examples. The training examples may be ranked in decreasing order of self-influence, i.e., calculate Score_e_e for all training examples e and examine them in descending Score_e_e order. Intuitively, a high self-influence indicates that the training example is highly responsible for reducing its own loss during the training process, in comparison to other training examples. This may be due to the example being an outlier or, as is often the case, mislabeled.

The Tracin method may be implemented in variations that further reduce processing costs while maintaining accuracy. One variation, termed Low Latency Implementation, pre-computes the gradients at the various recordings, on a per example basis, concatenates these gradients and stores the resulting vector in a vector database that supports nearest neighbor search. To find the example f with the highest Score_e_f the gradients for example f are computed across the recordings, concatenating them into a vector V and performing a nearest neighbor search for vector V in the vector database. Another variation is the Fast Random Projection method that utilizes a final fully connected layer of the model and employs random projection in its computation, thereby reducing the computational complexity.

Some exemplary further improvements to measuring unlearning quality are now described. Let D, Dr, and Df denote the set of examples, the set of examples to be retained (i.e., not removed) and the set of examples to be forgotten (i.e., removed), respectively. There have been a few attempts to define such measures which include:
Basic measures: accuracy on forget set, retain set, and test set. These are very basic measures. The values on these sets prior to unlearning may be compared-this is a good point of reference. If a sub-class is removed, this sub-class may be eliminated from the test set before comparing the pre-unlearnt and the unlearnt models. However, if each removed example has many similar retained examples, much change is not expected in these measures and good unlearning cannot be inferred from them. The accuracy on the test set is expected to be similar, on the retained set to be high and less on the forget set.
Various distance measures from a retrained from scratch model. There are a few such measures, for example weight-wise distance. However, this is not very practical as usually a model trained from scratch on the retained set is not available.
Re-learn Time: The unlearnt model is fine-tuned (after forgetting) and re-trained for a few iterations on a subset of the training data (which includes Df). The number of iterations it takes for this model to re-learn Df is recorded. A good forgetting procedure may be such that the re-learning time may be comparable to the time needed to train a model from scratch on the retained set. Re-learn time serves as a proxy for the information remaining in the weights of the unlearnt model about Df. The relearning computation is potentially costly and hence this measure is not considered practical.
The gold standard: the retrained from scratch model on the retained set of training examples. In the sequel a method for efficiently approximating the gold standard model is devised.
MIA: A Membership Inference Attack on a machine learning model tries to exploit the model's behavior to infer whether specific data was included in the model's training set. If the attack determines that a ‘forgotten’ example was used in training, intuitively it may be deduced that its removal is not ‘complete’. In the sequel this measure is examined and a method for improving it is devised.
ZRF: Devised in Vikram S. Chundawat [symbol] , Ayush K. Tarun, Murari Mandal, Mohan S. Kankanhalli: “Can Bad Teaching Induce Forgetting? Unlearning in Deep Networks Using an Incompetent Teacher”, AAAI 2023:7210-7217, incorporated herein by reference in its entirety. Calculate the average Jensen-Shannon (JS) divergence between distributions produced by the unlearned model M and a similar model Td initialized with random weights. For probability distributions denoted P and Q, JS(P∥Q)=0.5 KLD(P∥M)+0.5 KLD(Q∥M) where M=0.5(P+Q). In the context of at least one embodiment described herein, a probability distribution is produced by a model when presented with an example. For an example x, the JS in the context of at least one embodiment described herein uses model m(x)=(M(x)+Td(X))/2 to average the KL divergence between M(x) vs. m(x) and Td(x) vs. m(x). Then ZRF is defined as the average over all removed examples x of JS(M(x), Td(x)). In the sequel a method is devised for efficiently approximating the gold standard model. Using this approximation, the ZRF value may be obtained on the unlearned model and on the approximated gold standard model, a good unlearning implies that these two computed values should be close.
Activation Distance: We compute the distance between the final activations of the unlearnt model neurons (units) and the re-trained model on different subsets of data. This method is impractical during deployment time. However, we can use the approximated gold standard model for this computation.

Approximating the gold standard is now discussed. The gold standard measure aims to determine how closely the model after removal operates as compared to a model trained from scratch on the retained set. Implementing this measure in real-life is considered impractical as retraining from scratch defeats the purpose of unlearning without retraining from scratch. The challenge then is to obtain the information the retrained model would have provided without computing it.

Next a method for achieving the effect of having a good approximation of a model trained from scratch on the retained set, is described.

Consider Mb (model before removal), Ma (model after removal). Train Ms (model from scratch) on 10% of Dr (another constant percentage is possible). Let Mh be a hypothetical model trained only on Dr.

Consider a forgotten training example denoted f. Look at the outputs on Ms and Ma when presented with e. Compute the distance between e's output in them, dist(f, Ms, Ma). The dist measure may be KL-divergence, Euclidean distance between vectors of output logits, or some other distance measure. Compute the distance average over all removed examples (call it A_forget). If Ms models Mh well then Ma is a good un-learner if A_forget is small.

Consider a retained training example r. Look at the outputs on Ms and Ma when presented with r. Compute the distance between r's output in them, dist(r, Ms, Ma). Compute the distance average over a randomly chosen subset of the retained examples (call it A_retain). If Ms models Mh well then Ma is a good retainer if A_retain is small.

So, if Ms is a good approximation for Mh then both average distances should be small. So, for example, if A_forget is higher than A_retain (or vice versa) then Ma does not handle removed examples properly.

An important issue is that of the quality of Ms and its closeness to the hypothetical Mh. It is observed that the higher constant percentage parameter used, the higher the likelihood that Ms is functionally close to Mh (and the higher the computational cost).

One way to test the quality of Ms is that of training yet another model Mn on 15% of Dr, the starting point of training Mn can be a slight perturbation of Ms. Then the test set on both Ms and Mn is checked, if sufficiently close (a threshold) it is concluded that Ms is a good approximation of Mh. Otherwise, Mn becomes Ma and the procedure is replayed (that is use 20% of Dr for the “new” Mn). Therefore, an effective way of testing the quality of Ms is obtained.

The next issue is that of updating Ms when a further set of training examples is removed. Ms may be created anew after such a removal of a set of training examples. As training is expensive, a large set of examples may be removed each time so that the number of times Ms is formed anew, i.e., retrain it, is small.

Alternatively, recursive operation may be implemented as follows. Suppose a new set S is to be removed (the second removal) from Ma. Take the set T consisting of 10% (or another constant percentage parameter) of the retained data used to train Ms minus set S (so, these are examples to be retained after this second removal). T contains roughly 1% of original training data. Train a model Mss on T. Similarly, train Mnn on 15% of the retained data which contains T. Then, check the test set on both Mss and Mnn, if sufficiently close (a threshold) it may be concluded that Mss is a good approximation of Mh. This recursion may be problematic when 1% of the retained examples is too small and in such cases the percentage (10%) may be increased. At this point the removal on Ma may be formed and the quality of removal may be checked by comparing average distances when using Mss instead of Ms in the calculation. It is noted that in this recursive scheme, Mss and Mnn are trained only on retained examples which is the decisive characteristic of a gold standard model.

Next, it is shown how to improve the MIA in general and for evaluating unlearning quality in particular. Let UM be the unlearned model. There are a few methods for carrying out a membership inference attack. Carrying out a MIA for an example e computes the probability that e belongs to the training set of UM. Ideally, a forgetting procedure should result in the same success probability for a MIA attack on the unlearned model as that of a MIA attack on a re-trained from scratch model. Usually, retraining from scratch is impractical and instead one can use the approximations devised herein (Ms and Mss).

However, there is a deeper issue concerning using MIA. What MIA really computes is the probability that an example whose model output is like e was in the training set. Here the notion of similarity (as quantified by a distance measure) may vary depending on the specific implementation of MIA that is used. In the sequel it is assumed that each example may be represented by its activation vector(s) in the model when presented to the model. This is reasonable as similar examples will tend to score similarly in MIA as we detail.

For unlearning, if the score MIA(e, UM) is high, it may be simplistically deduced that e was part of the training set and therefore M contains information it should not have. However, the following cases may be examined.
Case 1: e is isolated and there are no examples in distance b (a parameter) from e. In this case the MIA score indeed measures the likelihood of e being in the training set.
Case 2: e is not isolated. Assume there are m examples within distance b from e and they are all retained. So, any of these m examples would also receive a score similar to MIA(c, UM). Intuitively, the MIA score for e may be “due” to any of these m examples that are like e. Therefore, there may be a need to scale down the MIA score to MIA(e, UM)/fun(m+1) where fun may be chosen to be the identity function, the square root function, the natural logarithm function, or some other function. The choice of function should reflect the cardinality of the set of examples in the b neighborhood of e. If m is small then the identity function is appropriate, if m is of intermediate size, then the square root is appropriate and if m is large then the natural logarithm is appropriate.
Case 3: e is not isolated. Assume there are m examples within distance b from e and q of them are removed as well. By a similar reasoning, the MIA score of any such removed example g should be adjusted to MIA(g, UM)/fun(m+1−q). Intuitively, the MIA score may be attributed to any of the retained (m-q) retained examples. It is observed that if all these m examples and e arc removed, then the MIA score should not be adjusted at all.

To determine the number of examples that are close to e in the remaining dataset, a vector database (VDB) may be kept and vector representations (obtained from the last layers(s)) of examples on the model may be stored and looked for the closest ones, up to distance b.

Exemplary approaches for how to use the influence of training examples on a trained model prediction to confirm and/or assess unlearning of a training example(s) are now provided. The description herein in terms of classification neural networks is meant to be exemplary and not necessarily limiting. It is noted that as long as a loss computation on a presented example is enabled, embodiments described herein would work as well on other machine learning model architectures. In particular, embodiments may be applied to other machine learning model architectures when a training example is a sequence of tokens presented to the trained model and its predicted outputs can be used to compute a loss.

At least one approach for testing how much influence a training example denoted f has on a specific prediction on an example denoted e by a trained model denoted M, is described herein. For example, by using the Tracin approach or an alternative mechanism to track loss changes or proxies thereof. After removing from the trained model a unlearning example denoted e (i.e., a training example), e's label may be predicted by using the unlearned (modified) model M′. M′ may be produced for example by one of the unlearning methods described herein denoted 1,2,3 or variations thereof. A test for evaluating how much influence e as a training example had on this prediction of M′ on e's input features, may be applied. The principle being that if the influence is high, “traces” of e likely remained in M′. Recall that is some embodiments the influence method works by considering the training process of M and not that of M′, therefore its results may not be completely trustworthy in case M′ was derived from M using a “neurosurgical” weight altering approach (like the SSD method). However, if M′ was derived from M using a careful fine tuning process, for example such as methods described herein denoted 1,2,3 or their variations, weight changes may be tracked using recordings (e.g., checkpoints) and this influence-based method to confirm unlearning might be used. If in testing on M′ it is discovered that e itself has a very significant influence on M′ prediction on e's input features, it may be deduced that the unlearning was not well accomplished. In this case, the fine tuning process may be continued and/or fine tuning may be started from an earlier recording (e.g., an earlier checkpoint).

An exemplary approach for confirming effective removal of an unlearning training example from a model is provided. An influence of the unlearning training example on a prediction of an unlearned version of the model is checked on an input of a removed unlearned training example during training. In response to the influence being higher according to a requirement in comparison with the influence on the prediction by at least one other training example, an indication that the removal is insufficient is generated. The requirement may be, for example, a threshold, a function of the influence of the unlearning training example above the influence by at least one other training example (e.g., percentage, value), and the like. Optionally, in response to the generation of the indication that the removal is insufficient, further unlearning actions may be performed, automatically and/or manually. Examples of further unlearning actions include further weight changes to effect unlearning and/or using an earlier recording with which to begin unlearning actions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant models will be developed and the scope of the term model is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of unlearning a training example from a neural network, comprising:
during training of the neural network on a training dataset, recording a plurality of recordings in a recording dataset, wherein a recording includes weight values of the neural network at the time at which the recording is recorded;
selecting an unlearning training example to unlearn from the neural network;
computing a total-loss value of a change in a loss function for each of plurality of training examples induced by a change of weights of the neural network in response to the unlearning training example;
determining a certain recording to use to remove the unlearning training example according to the total-loss values; and
re-training the neural network from the determined certain recording using an adapted training dataset excluding the unlearning training example; and producing an unlearned neural network.

2. The computer implemented method of claim 1, wherein the recording includes a checkpoint comprising: (i) a change in a loss function value for a first training example induced by a change of weights of the neural network in response to a second training example, and (ii) a time during the training associated with the change in the loss function value,
wherein the first training example and the second training example are selected from a plurality of training examples of the training dataset.

3. The computer implemented method of claim 1, wherein in response to determining that the total-loss is within a range indicating non-significant overall loss, removing the unlearning training example with no neural network weight alteration.

4. The computer implemented method of claim 1, wherein in response to determining that the total-loss is greater than a first threshold indicating the unlearning example significantly reduced overall loss during training, identifying a recording with an increase in loss as compared to the latest recording greater than a second threshold, and re-training the neural network starting from the identified recording on an adapted training dataset that excludes the unlearning training example.

5. The computer implemented method of claim 1, wherein in response to determining that the total-loss is less than a second threshold indicating the unlearning example significantly increased overall loss during training, re-training the neural network from the most recent recording on an adapted training dataset that excludes the unlearning training example.

6. The computer implemented method of claim 1, the unlearning training example comprises a plurality of unlearning training examples, wherein the selected recording providing at least a defined percentage of improvement in the overall model loss over all training examples thereafter until the most recent available recording.

7. The computer implemented method of claim 1, further comprising:
training a second neural network on a second training dataset of a plurality of records, wherein a record includes a training example of the neural network, or a record includes an example from a held out test set of examples that have not participated in training or another previously removed unlearned example, a loss computed by an unlearned neural network when presented with the unlearned training example, and a binary label indicating whether the unlearned training example is a training example, or a held out example or a previously removed example;
feeding the unlearned example into the second neural network;
in response to an outcome of the second neural network indicating a training example, generating an indication that the removal of the unlearning example is insufficient.

8. The computer implemented method of claim 1, further comprising confirming the effective removal of the unlearning training example from the neural network, by:
checking an influence of the unlearning training example on a prediction of an unlearned version of the neural network on an input during training of a removed unlearned training example; and
in response to the influence being higher according to a requirement in comparison with the influence on the prediction by at least one other training example, generating an indication that the removal is insufficient.

9. A method of unlearning a training example from a neural network, comprising:
during training of the neural network on a training dataset, recording a plurality of recordings in a recording dataset, wherein a recording includes weights values of the neural network at a time in which the recording is recorded;
selecting an unlearning training example to unlearn from the neural network;
providing per recording, a total-loss-change parameter as an overall loss reduction effect of the unlearning training example on at least one different training example,
computing per recording, a total sum of values or of absolute values, of the total-loss change parameter for the plurality of training examples; and
assigning a weight for each of the plurality of training examples; and
using the weight of each training example to modify its impact on loss computation during further training to account for the removal of the unlearning training example on each of the plurality of training examples' associated loss, said further training computed from a preceding recording and/or from a current recording forward.

10. The computer implemented method of claim 9, wherein a value of the total-loss-change parameter>0 indicates loss reduction for a certain different training example due to the unlearning training example, and wherein a value of the total-loss-change parameter<0 indicates loss increase for the certain different training example due to the unlearning training example.

11. The computer implemented method of claim 9, wherein in further training the weight of each training example is increased in proportion to a magnitude of an absolute value of a total-loss-change parameter of the training example due to the unlearning example relative to a sum of the magnitudes of total-loss-change parameters of the plurality of training examples due to the unlearning example.

12. The computer implemented method of claim 9, wherein the total sum of values comprises the total sum of the absolute values, and in response to the total sum exceeding a threshold, adjusting the total sum according to a threshold.

13. The computer implemented method of claim 9, wherein a value of a current weight of a certain training example is defined as a value of the current weight plus a variable-parameter multiplied by an absolute value of the total-loss-change parameter for the certain training example divided by the sum of absolute values of the total-loss-change parameter of all the training examples.

14. The computer implemented method of claim 9, wherein a value of a current weight of a certain training example is defined as a value of its current weight minus a positive value variable-parameter multiplied by the value of the total-loss-change parameter for the certain training example divided by the sum of absolute values of the total-loss-change parameter of all the training examples.

15. The computer implemented method of claim 9, wherein a plurality of the weights are computed by solving a linear equation of a form M*Q=−J wherein Q denote a column vector of variables, M denotes a matrix of n squared entries wherein n is the number of training examples, and wherein the entry M_im entry at row i and column m is a total loss influence of a training example e_i on a training example e_m, J denotes a column vector, wherein its m'th entry J_m is the total-loss change of training example e_m due to the unlearning training example, wherein the linear equation is solved for the variables, using each variable to adjust each corresponding weight of a corresponding training example.

16. A computer implemented method for unlearning a text element from a large language model (LLM), comprising:
accessing the text element for unlearning,
wherein the text element is represented as a plurality of tokens;
generating a plurality of text training examples by changing a token or a series of contiguous tokens by replacing the token or the series of tokens by another token or another series of token by randomly selecting among candidate tokens with a probability above a threshold according to a prediction of the LLM on the text element when the token or the series is masked away from the LLM input; and
training the LLM on the plurality of text training examples to create an adapted LLM for which it is determined that the text element has been sufficiently unlearned.

17. The computer implemented method of claim 16, further comprising:
accessing vector embeddings of a plurality of text training examples used to train the generative model;
computing a text vector embedding of the text element;
searching for the text vector embedding within the vector embeddings of the plurality of text training examples;
identifying vector embeddings in proximity to the text vector embedding and
unlearning according to at least one of (i) a whole text training example corresponding to identified vector embeddings, and (ii) a sub-text of the whole text training example including the text element, (iii) retain the whole text training example without unlearning, or (iv) choose probabilistically among options (i), (ii) and (iii).

18. The computer implemented method of claim 16, further comprising determining that the text element has been sufficiently unlearned by:
for each presentation of the text element and each of the plurality of text training examples presented separately to the LLM excluding masking, computing a distance between the LLM's prediction and the presentation to the LLM;
listing the text element and each of the plurality of text training examples according to an increasing distance order; and
in response to the text element being excluded from an initial portion of the list satisfying a requirement indicating a small distance, it is determined that the text element has been sufficiently unlearned by the LLM.

19. The computer implemented method of claim 18, wherein the distance comprises a number of mis-predicted tokens.

20. The computer implemented method of claim 16, wherein the LLM is at least one of: (i) has been previously trained using a non-supervised approach, (ii) comprises a fine-tuned pre-trained LLM model trained with labelled data, and (iii) comprises a fine-tuned LLM model trained using an unsupervised approach, wherein the token or series of tokens that is replaced is used in the fine tuning.

21. The computer implemented method of claim 16, wherein the LLM model comprises a generative model for generating images, wherein the text element is obtained by an image-to-text conversion process in which image data is pre-processed to extract features and/or information from the image which is described as text.
